(19) United States
(12) Patent Application Publication
(10) Pub. No.: US 2026/0194732 A1
(43) Pub. Date: Jul. 9, 2026

(54) OPTICAL SYSTEM AND CAMERA MODULE COMPRISING SAME

(71) Applicant: LG INNOTEK CO., LTD., Seoul (KR)

(72) Inventor: Duk Keun KWON, Seoul (KR)

(21) Appl. No.: 18/865,186

(22) PCT Filed: May 22, 2023
(86) PCT No.: PCT/KR2023/006951

§ 371 Date: Nov. 12, 2024

(30) Foreign Application Priority Data
May 20, 2022 (KR) 10-2022-0062218

(51) Int. Cl. G02B 13/00; G02B 3/00; G02B 9/64; H04N 23/55

(52) U.S. Cl. CPC G02B 13/0045; G02B 9/64; H04N 23/55; G02B 2003/0093

(57) ABSTRACT

The optical system disclosed in the embodiment of the invention includes first to eighth lenses disposed along an optical axis in a direction from an object side to a sensor side, wherein the first lens has a positive (+) refractive power on the optical axis and has a convex object-side surface, when a refractive index (n1) of the first lens and a refractive index (n2) of the second lens, the following Equation satisfies: 0<n1/n2<1, a number of lenses having a meniscus shape convex toward the object side on the optical axis OA among the first to eighth lenses is five or more, each of an object-side and sensor-side surfaces of the sixth lens has a critical point, each of an object-side and sensor-side surfaces of the seventh lens has a critical point, and the critical point of the sensor-side surface of the seventh lens may be disposed further outside than the critical points of the object-side surface and the sensor-side surface of the sixth lens based on the optical axis.

### TECHNICAL FIELD

An embodiment relates to an optical system for improved optical performance and a camera module including the same.

### BACKGROUND ART

The camera module captures an object and stores it as an image or video, and is installed in various applications. In particular, the camera module is produced in a very small size and is applied to not only portable devices such as smartphones, tablet PCs, and laptops, but also drones and vehicles to provide various functions.

For example, the optical system of the camera module may include an imaging lens for forming an image, and an image sensor for converting the formed image into an electrical signal. In this case, the camera module may perform an autofocus (AF) function of aligning the focal lengths of the lenses by automatically adjusting the distance between the image sensor and the imaging lens, and may perform a zooning function of zooming up or zooning out by increasing or decreasing the magnification of a remote object through a zoom lens. In addition, the camera module employs an image stabilization (IS) technology to correct or prevent image stabilization due to an unstable fixing device or a camera movement caused by a user's movement.

The most important element for the camera module to obtain an image is an imaging lens that forms an image. Recently, interest in high efficiency such as high image quality and high resolution is increasing, and research on an optical system including plurality of lenses is being conducted in order to realize this. For example, research using a plurality of imaging lenses having positive (+) and/or negative (−) refractive power to implement a high-efficiency optical system is being conducted.

However, when a plurality of lenses is included, there is a problem in that it is difficult to derive excellent optical properties and aberration properties. In addition, when a plurality of lenses is included, the overall length, height, etc. may increase due to the thickness, distance, size, etc. of the plurality of lenses, thereby increasing the overall size of the module including the plurality of lenses.

In addition, the size of the image sensor is increasing to realize high-resolution and high-definition. However, when the size of the image sensor increases, TTL (Total Track Length) of the optical system including the plurality of lenses also increases, thereby increasing the thickness of the camera and the mobile terminal including the optical system. Therefore, a new optical system capable of solving the above problems is required.

### DISCLOSURE

### Technical Problem

An embodiment of the invention provides an optical system with improved optical properties. The embodiment provides an optical system having excellent optical performance at the center and periphery portions of the field of view. The embodiment provides an optical system capable of having a slim structure.

### Technical Solution

An optical system according to an embodiment of the invention comprises first to eighth lenses disposed along an optical axis in a direction from an object side to a sensor side, wherein the first lens has a positive (+) refractive power on the optical axis and has a convex object-side surface, when a refractive index (n1) of the first lens and a refractive index (n2) of the second lens, the following Equation satisfies: 0<n1/n2<1, a number of lenses having a meniscus shape convex toward the object side on the optical axis OA among the first to eighth lenses is five or more, each of an object-side and sensor-side surfaces of the sixth lens has a critical point, each of an object-side and sensor-side surfaces of the seventh lens has a critical point, and the critical point of the sensor-side surface of the seventh lens may be disposed further outside than the critical points of the object-side surface and the sensor-side surface of the sixth lens based on the optical axis.

According to an embodiment of the invention, an object-side surface of the eighth lens is provided without a critical point, a sensor-side surface of the eighth lens has a critical point, and the critical point of the eighth lens may be disposed closer to the optical axis than the critical points of the object-side and sensor-side surfaces of the sixth lens.

According to an embodiment of the invention, the refractive index of the first lens may satisfy: 1.50<n1<1.6, and the refractive index of the second lens may satisfy: 1.65<n2.

According to an embodiment of the invention, the first, second, third, fifth, and sixth lenses may have a meniscus shape convex toward the object side on the optical axis. The seventh lens may have a meniscus shape convex toward the object side on the optical axis.

According to an embodiment of the invention, a maximum effective diameter (CA_max) of object-side and sensor-side surfaces of the first to eighth lenses satisfies the following Equation: 0.1<CA_max/(2*ImgH)<1, and the ImgH is ½ of a maximum diagonal length of an image sensor.

According to an embodiment of the invention, the sensor-side surface of the eighth lens has a maximum effective diameter (CA_max) among the object-side and sensor-side surfaces of the first to eighth lenses, and the following Equation may satisfy: 0.5<TTL/CA_max<2, and the TTL may be an optical axis distance from the object-side surface of the first lens to an image surface of the image sensor.

According to an embodiment of the invention, a focal length (F1) of the first lens and a total focal length (F) may satisfy the following Equation: 0<F1/F<3. The focal length (F1) of the first lens and the focal length (F2) of the second lens may satisfy the following Equation: −1<F1/F2<0.

According to an embodiment of the invention, the center thickness (CT6) of the sixth lens and the center thickness (CT7) of the seventh lens may satisfy an Equation: 0<CT6/CT7<1.

According to an embodiment of the invention, the effective diameter of the object-side surface of the first lens is CA_L1S1, the object-side effective diameter of the third lens is CA_L3S1, and the sensor-side effective diameter of the eighth lens is CA_L8S2, and the following Equations may satisfy: 1<CA_L1S1/CA_L3S1<2 and 1<CA_L8S2/CA_L1S1<5.

An optical system according to an embodiment of the invention includes first to third lenses disposed on an object side; fourth to eighth lenses disposed on the sensor side; and an aperture stop disposed around a sensor-side surface of any one of the first to third lenses, wherein the sensor-side surface of the third lens faces the object-side surface of the fourth lens, and the sensor-side surface of the third lens has a concave shape on the optical axis, the object-side surface of the fourth lens has a convex shape on the optical axis, and the first to third lenses have a meniscus shape convex toward the object side on the optical axis, the effective diameters of the object-side and sensor-side surfaces of the first to third lenses gradually decrease from the object side toward the sensor side, and the effective diameters of the object-side and sensor-side surfaces of the fourth to eighth lenses may gradually increase from the object side to the sensor side.

According to an embodiment of the invention, when a composite focal length from the first lens to the third lens is F13 and a composite focal length from the fourth lens to the eighth lens is F48, and the following Equation may satisfy: 1<|F48/F13|<4. The aperture stop is disposed around the sensor-side surface of the second lens, a composite focal length from the first lens to the second lens is F12, and a composite focal length from the third lens to the eighth lens is F38, the following Equations may satisfy: F12>F13 and |F38|>|F48|.

According to an embodiment of the invention, the object-side surface and the sensor-side surface of the sixth lens have a critical point, the sensor-side surface of the seventh lens has a critical point, a distance from the optical axis to the critical point of the object-side surface of the sixth lens is Inf61, a distance from the optical axis to the critical point of the sensor-side surface of the sixth lens is Inf62, a distance from the optical axis to the critical point of the sensor-side surface of the seventh lens is Inf72, and the following Equations may satisfy: 0<Inf61/Inf62<1, 0<Inf61/Inf72<1, and 0<Inf62/Inf72<1.

According to an embodiment of the invention, a curvature radius of the object-side surface of the first lens is L1R1, a curvature radius of the sensor-side surface of the first lens is L1R2, and the curvature radius of the object-side surface of the second lens is L2R1, and a curvature radius of the sensor-side surface of the second lens is L2R2, and the following Equations may satisfy: 0<L1R1/L1R2<1 and 0<L2R2/L2R1<1.

According to an embodiment of the invention, the object-side surface and the sensor-side surface of the eighth lens have an aspherical shape on the optical axis, and a distance between the sensor-side surface of the eighth lens and the image sensor may satisfy the following Equation: 1<BFL/L8S2_max_sag to Sensor<2, the BFL is an optical axis distance from a center of the sensor-side surface of the eighth lens to the image sensor, and the L8S2_max_sag to Sensor is a distance from a maximum Sag value of the sensor-side surface of the eighth lens to the image sensor.

According to an embodiment of the invention, a center thickness CT1 of the first lens, a center thickness CT2 of the second lens, and a center thickness CT7 of the seventh lens may satisfy the following Equations: 2<CT1/CT2<4 and 0<CT1/CT7<2.

According to an embodiment of the invention, a sum (ΣCT) of center thicknesses of the first to eighth lenses and a sum (ΣCG) of distances between two adjacent lenses may satisfy the following Equation: 1<ΣCT/ΣCG<1.8.

A camera module according to an embodiment of the invention includes an image sensor; and an optical filter disposed between the image sensor and a last lens, wherein an optical system includes a optical system disclosed above, and the following Equations satisfy: 0.5<F/TTL<1.5 and 0.5<TTL/ImgH<3, where F is average of a total focal lengths in two directions orthogonal to the optical axis of the optical system, TTL (Total track length) is a distance from a center of the object-side surface of the first lens to the image surface of the image sensor on the optical axis, and ImgH is ½ of a maximum diagonal length of the image sensor.

### Advantageous Effects

The optical system and the camera module according to the embodiment may have improved optical properties. In detail, the optical system may have improved aberration characteristics and resolving power according to the surface shape, refractive power, thickness of a plurality of lenses and distance between adjacent lenses of a plurality of lenses.

The optical system and the camera module according to the embodiment may have improved distortion and aberration characteristics, and may have good optical performance at the center and periphery portions of the field of view (FOV). The optical system according to the embodiment may have improved optical characteristics and a small total track length (TTL), so that the optical system and a camera module including the same may be provided in a slim and compact structure.

### DESCRIPTION OF DRAWINGS

FIG. 1 is a configuration diagram of an optical system and a camera module according to an embodiment(s) of the invention.

FIG. 2 is an explanatory diagram illustrating a relationship between an image sensor, an n-th lens, and an n−1th lens of the optical system of FIG. 1.

FIG. 3 is a table showing lens data according to the first embodiment having the optical system of FIG. 1.

FIG. 4 is an example of aspherical surface coefficients of lenses according to the first embodiment of the invention.

FIG. 5 is a table showing thicknesses of lenses and distances between lenses according to a direction orthogonal to an optical axis in an optical system according to a first embodiment of the invention.

FIG. 6 is a table showing Sag values of the object-side surface and the sensor-side surface of the seventh and eighth lenses according to the first embodiment of the invention.

FIG. 7 is a graph showing ray aberration characteristics of the optical system according to the first embodiment of the invention.

FIG. 8 is a graph showing aberration characteristics of the optical system according to the first embodiment of the invention.

FIG. 9 is a table showing lens data according to a second embodiment having the optical system of FIG. 1.

FIG. 10 is an example of aspherical surface coefficients of lenses according to a second embodiment of the invention.

FIG. 11 is a table showing thicknesses of lenses and distances between lenses along a direction orthogonal to an optical axis in an optical system according to a second embodiment of the invention.

FIG. 12 is a table showing Sag values of the object-side surface and the sensor-side surface of the seventh and eighth lenses according to the second embodiment of the invention.

FIG. 13 is a graph showing ray aberration characteristics of an optical system according to a second embodiment of the invention.

FIG. 14 is a graph showing aberration characteristics of the optical system according to the second embodiment of the invention.

FIG. 15 is a graph showing Sag values for object-side surfaces and sensor-side surfaces of seventh and eighth lenses according to an embodiment of the invention.

FIG. 16 is a diagram illustrating that a camera module according to an embodiment is applied to a mobile terminal.

### BEST MODE

Hereinafter, preferred embodiments of the invention will be described in detail with reference to the accompanying drawings. A technical spirit of the invention is not limited to some embodiments to be described, and may be implemented in various other forms, and one or more of the components may be selectively combined and substituted for use within the scope of the technical spirit of the invention. In addition, the terms (including technical and scientific terms) used in the embodiments of the invention, unless specifically defined and described explicitly, may be interpreted in a meaning that may be generally understood by those having ordinary skill in the art to which the invention pertains, and terms that are commonly used such as terms defined in a dictionary should be able to interpret their meanings in consideration of the contextual meaning of the relevant technology.

The terms used in the embodiments of the invention are for explaining the embodiments and are not intended to limit the invention. In this specification, the singular forms also may include plural forms unless otherwise specifically stated in a phrase, and in the case in which at least one (or one or more) of A and (and) B, C is stated, it may include one or more of all combinations that may be combined with A, B, and C. In describing the components of the embodiments of the invention, terms such as first, second, A, B, (a), and (b) may be used. Such terms are only for distinguishing the component from other component, and may not be determined by the term by the nature, sequence or procedure etc. of the corresponding constituent element. And when it is described that a component is “connected”, “coupled” or “joined” to another component, the description may include not only being directly connected, coupled or joined to the other component but also being “connected”, “coupled” or “joined” by another component between the component and the other component. In addition, in the case of being described as being formed or disposed “above (on)” or “below (under)” of each component, the description includes not only when two components are in direct contact with each other, but also when one or more other components are formed or disposed between the two components. In addition, when expressed as “above (on)” or “below (under)”, it may refer to a downward direction as well as an upward direction with respect to one element.

In the description of the invention, “object-side surface” may refer to a surface of the lens facing the object side with respect to the optical axis OA, and “sensor-side surface” may refer to a surface of the lens facing the imaging surface (image sensor) with respect to the optical axis. A convex surface of the lens may mean that the lens surface on the optical axis has a convex shape, and a concave surface of the lens may mean that the lens surface on the optical axis has a concave shape. A curvature radius, center thickness, and distance between lenses described in the table for lens data may mean values on the optical axis, and the unit is mm. The vertical direction may mean a direction perpendicular to the optical axis, and an end of the lens or the lens surface may mean the end or edge of the effective region of the lens through which the incident light passes. The effective diameter on the lens surface may have a measurement error of up to ±0.4 mm depending on the measurement method. The paraxial region refers to a very narrow region near the optical axis, and is a region in which a distance at which a light ray falls from the optical axis OA is almost zero. Hereinafter, the concave or convex shape of the lens surface will be described as an optical axis, and may also include a paraxial region.

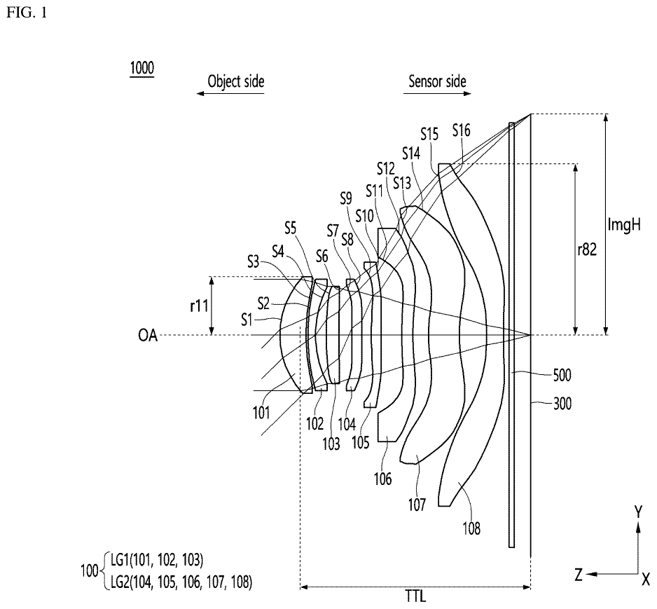

FIG. 1 is a diagram showing an optical system 1000 and a camera module having the same according to first and second embodiments of the invention.

Referring to FIG. 1, an optical system 1000 or a camera module may include a plurality of lens groups LG1 and LG2. In detail, each of the plurality of lens groups LG1 and LG2 includes at least one lens. For example, the optical system 1000 may include a first lens group LG1 and a second lens group LG2 sequentially disposed in the optical axis OA toward the image sensor 300 from the object side. The number of lenses of the second lens group LG2 may be greater than the number of lenses of the first lens group LG1, and may be, for example, more than one to two times less than the number of lenses of the first lens group LG1.

The first lens group LG1 may include two or more lenses. The first lens group LG1 may include three or less lenses. For example, the first lens group LG1 may include three lenses. The second lens group LG2 may include three or more lenses. The second lens group LG2 may include more lenses than the number of lenses of the first lens group LG1, for example, 7 or less or 6 or less lenses. The number of lenses of the second lens group LG2 may be greater than the number of lenses of the first lens group LG1 by three or more. For example, the second lens group LG2 may include 5 lenses.

In the optical system 1000, the total track length (TTL) may be less than 70% of the diagonal length of the image sensor 300, for example, in the range of 40% to 69% or 50% to 60%. The TTL is the distance on the optical axis OA from the object-side surface of the first lens 101 closest to the object side to the image surface of the image sensor 300, and the diagonal length of the image sensor 300 is a maximum diagonal length of the image sensor 300 and may be twice the distance ImgH from the optical axis OA to the diagonal end of the image sensor 300. Accordingly, it is possible to provide a slim optical system and a camera module having the same. The total number of lenses of the first and second lens groups LG1 and LG2 is 7 to 9.

The first lens group LG1 may have positive (+) refractive power. The second lens group LG2 may have a different negative (−) refractive power than the first lens group LG1. The first lens group LG1 and the second lens group LG2 may have different focal lengths and opposite refractive powers, thereby providing good optical performance at the center and periphery portions of the FOV. The refractive power is the reciprocal of the focal length.

When expressed as an absolute value, the focal length of the second lens group LG2 may be greater than that of the first lens group LG1. For example, the absolute value of the focal length F_LG2 of the second lens group LG2 may be 1.4 times or more, for example, in a range of 1.4 times to 2 times the absolute value of the focal length F_LG1 of the first lens group LG1.

Accordingly, the optical system 1000 according to the embodiment may have improved aberration control characteristics such as chromatic aberration and distortion aberration by controlling the refractive power and focal length of each lens group, and good optical performance in the center and periphery portions of the FOV.

In the optical axis OA, the first lens group LG1 and the second lens group LG2 may have a set distance. The optical axis distance between the first lens group LG1 and the second lens group LG2 on the optical axis OA is the separation distance on the optical axis OA, and may be a optical axis distance between the sensor-side surface of the lens closest to the sensor among the lenses in the first lens group LG1 and the object-side surface of the lens closest to the object among the lenses in the second lens group LG2. The optical axis distance between the first lens group LG1 and the second lens group LG2 may be greater than the center thickness of the lens, which is the last of the lenses of the first lens group LG1 and the center thickness of the lens, which is the first of the lenses in the second lens group LG2. The optical axis distance between the first lens group LG1 and the second lens group LG2 may be less than the optical axis distance of the first lens group LG1 and is 20% or less of the optical axis distance of the first lens group LG1, and for example, may be in the range of 5% to 15% or 5% to 12% of the optical axis distance of the first lens group LG1. Here, the optical axis distance of the first lens group LG1 is the optical axis distance between the object-side surface of the lens closest to the object side of the first lens group LG1 and the sensor-side surface of the lens closest to the sensor side.

The optical axis distance between the first lens group LG1 and the second lens group LG2 may be 10% or less of the optical axis distance of the second lens group LG2, for example, in a range of 2% to 10% or 2% to 6%. The optical axis distance of the second lens group LG2 is the optical axis distance between the object-side surface of the lens closest to the object side of the second lens group LG2 and the sensor-side surface of the lens closest to the sensor side.

A lens having the smallest effective diameter in the first lens group LG1 may be a lens closest to the second lens group LG2. A lens having the smallest effective diameter in the second lens group LG2 may be a lens closest to the first lens group LG1. Here, the effective diameter is an average value of the effective diameters of the object-side surface and the effective diameter of the sensor-side surface of each lens. Accordingly, the optical system 1000 may have good optical performance not only at the center portion of the field of view (FOV) but also at the periphery portion, and may improve chromatic aberration and distortion aberration. A size of a lens having a minimum effective diameter in the first lens group LG1 may be smaller than a size of a lens having a minimum effective diameter in the second lens group LG2.

The optical system 1000 may include 10 or less lenses or 9 lenses or less. The first lens group LG1 refracts the light incident through the object side to converge, and the second lens group LG2 may refract light emitted through the first lens group LG1 so as to spread to the periphery portion of the image sensor 300.

Among the lenses of the first lens group LG1, the lens closest to the object side has positive (+) refractive power, and among the lenses of the second lens group LG2, the lens closest to the sensor side may have negative (−) refractive power. In the optical system 1000, the number of lenses having positive (+) refractive power may be greater than the number of lenses having negative (−) refractive power. In the first lens group LG1, the number of lenses having positive (+) refractive power may be greater than the number of lenses having negative (−) refractive power. In the second lens group LG2, the number of lenses having positive (+) refractive power may be smaller than the number of lenses having negative (−) refractive power.

Each of the plurality of lenses 100 may include an effective region and a non-ineffective region. The effective region may be a region through which light incident to each of the lenses 100 passes. That is, the effective region may be an effective region or an effective diameter region in which optical properties are implemented by refracting incident light. The non-effective region may be arranged around the effective region. The non-ineffective region may be a region in which effective light from the plurality of lenses 100 is not incident. That is, the non-effective region may be a region unrelated to the optical characteristics. Also, an end of the non-effective region may be a region fixed to a barrel (not shown) accommodating the lens.

The optical system 1000 may include an image sensor 300. The image sensor 300 may detect light and convert it into an electrical signal. The image sensor 300 may detect light sequentially passing through the plurality of lenses 100. The image sensor 300 may include a device capable of sensing incident light, such as a charge coupled device (CCD) or a complementary metal oxide semiconductor (CMOS). The diagonal length of the image sensor 300 may be greater than 2 mm, for example greater than 4 mm and less than 12 mm. Preferably, ImgH of the image sensor 300 may be smaller than TTL.

The optical system 1000 may include an optical filter 500. The optical filter 500 may be disposed between the second lens group LG2 and the image sensor 300. The optical filter 500 may be disposed between a lens closest to a sensor side among the plurality of lenses 100 and the image sensor 300. For example, when the optical system 100 has 8 lenses, the optical filter 500 may be disposed between the eighth lens 108 and the image sensor 300.

The optical filter 500 may include an infrared filter. The optical filter 500 may pass light of a set wavelength band and filter light of a different wavelength band. When the optical filter 500 includes an infrared filter, radiant heat emitted from external light may be blocked from being transferred to the image sensor 300. In addition, the optical filter 500 can transmit visible light and reflect infrared light. As another example, a cover glass may be further disposed between the optical filter 500 and the image sensor 300.

The optical system 1000 according to the embodiment may include an aperture stop ST. The aperture stop ST may control the amount of light incident on the optical system 1000. The aperture stop ST may be disposed around at least one lens of the first lens group LG1. For example, the aperture stop ST may be disposed around an object-side surface or a sensor-side surface of the second lens 102. The aperture stop ST may be disposed between two adjacent lenses 101 and 102 among the lenses in the first lens group LG1. Alternatively, at least one lens selected from among the plurality of lenses 100 may serve as an aperture stop. In detail, an object-side surface or a sensor-side surface of one lens selected from among the lenses of the first lens group LG1 may serve as an aperture stop for adjusting the amount of light.

A straight distance from the aperture stop ST to the sensor-side surface of the n-th lens may be smaller than an optical axis distance from the object-side surface of the first lens 101 to the sensor-side surface of the n-th lens. When SD is the optical axis distance from the aperture stop ST to the sensor-side surface of the n-th lens, SD<EFL may be satisfied. In addition, SD<ImgH may be satisfied. The EFL is the effective focal length of the entire optical system and may be defined as F. The EFL and ImgH may be the same as or different from each other, and may have a difference of 2 mm or less. The FOV of the optical system 1000 may be less than 120 degrees, for example, more than 70 degrees and less than 100 degrees. The F number (F#) of the optical system 1000 may be greater than 1 and less than 10, for example, 1.1≤F#≤5. Also, the F# may be smaller than the entrance pupil diameter (EPD). Accordingly, the optical system 1000 has a slim size, may control incident light, and may have improved optical characteristics within a FOV.

The effective diameter of the lenses gradually decreases from the object-side lens to the lens surface (e.g., the fourth surface) on which the aperture stop is disposed, and may gradually increase from the effective diameter of the lens surface (e.g., fifth surface) located on the sensor side than the aperture stop to the effective diameter of the lens surface of the last lens.

The optical system 1000 according to the embodiment may further include a reflective member (not shown) for changing a path of light. The reflective member may be implemented as a prism that reflects incident light of the first lens group LG1 toward the lenses. Hereinafter, an optical system according to an embodiment will be described in detail.

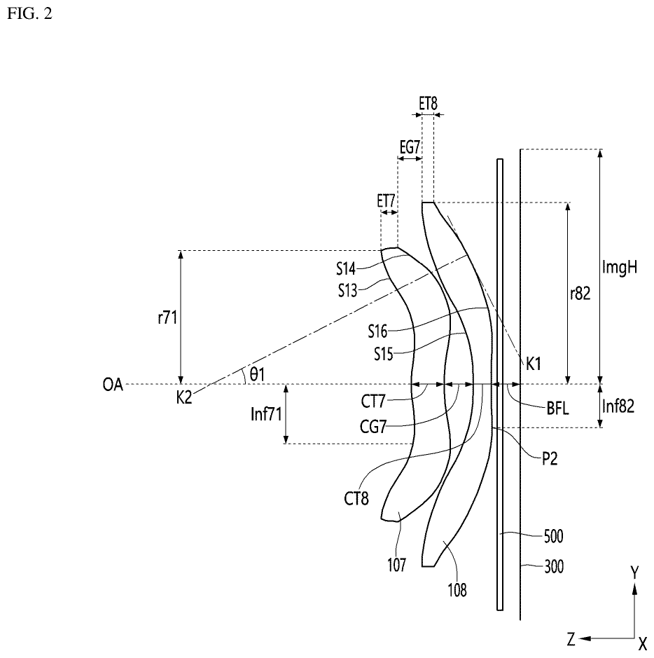

FIG. 1 is a configuration diagram of an optical system and a camera module according to an embodiment(s) of the invention, and FIG. 2 is an explanatory diagram showing the relationship between an image sensor, an n-th lens, and an n−1th lens of the optical system of FIG. 1.

Referring to FIGS. 1 and 2, optical systems 1000 according to the first and second embodiments include a lens portion 100 having a plurality of lenses, and the lens portion 100 includes a first lens 101 to an eighth lens 108. The first to eighth lenses 101 to 108 may be sequentially aligned in the optical axis OA of the optical system 1000. Light corresponding to object information may pass through the first lens 101 to the eighth lens 108 and the optical filter 500 and be incident on the image sensor 300.

The first lens group LG1 may include the first to third lenses 101 to 103, and the second lens group LG2 may include the fourth to eighth lenses 104 to 108. The optical axis distance between the third lens 103 and the fourth lens 104 may be the optical axis distance between the first and second lens groups LG1 and LG2. Among the first to eighth lenses 101 to 108, the number of lenses having a meniscus shape that is convex toward the object side on the optical axis may be 5 or more, and may satisfy: n−2. The n is the total number of lenses, and may be, for example, 8.

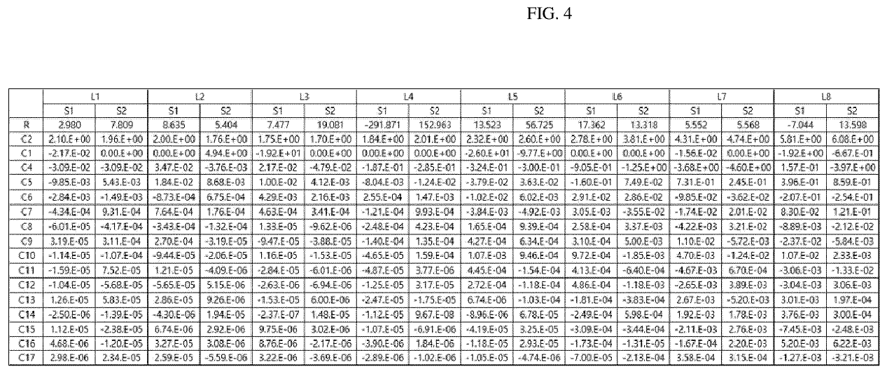

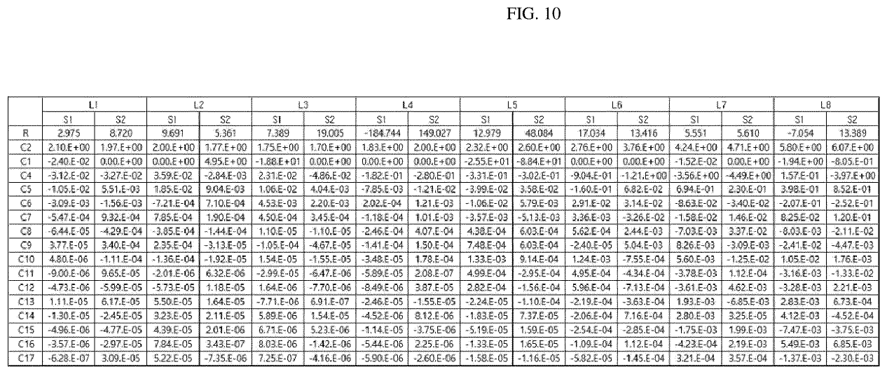

The first lens 101 may have negative (−) or positive (+) refractive power on the optical axis OA, and may preferably have positive (+) refractive power. The first lens 101 may include a plastic or glass material. For example, the first lens 101 may be made of a plastic material. The first lens 101 may include a first surface S1 defined as an object-side surface and a second surface S2 defined as a sensor-side surface. In the optical axis OA, the first surface S1 may have a convex shape, and the second surface S2 may have a concave shape. That is, the first lens 101 may have a meniscus shape convex toward the object side on the optical axis OA. At least one of the first surface S1 and the second surface S2 may be an aspheric surface. For example, both the first surface S1 and the second surface S2 may be aspherical. The aspheric coefficients of the first and second surfaces S1 and S2 are provided as shown in FIGS. 4 and 10, L1 is the first lens 101, L1S1 is the first surface, and L1S2 is the second surface.

The second lens 102 may have positive (+) or negative (−) refractive power on the optical axis OA. The second lens 102 may have negative (−) refractive power. The second lens 102 may include a plastic or glass material. For example, the second lens 102 may be made of a plastic material. The second lens 102 may include a third surface S3 defined as an object-side surface and a fourth surface S4 defined as a sensor-side surface. On the optical axis OA, the third surface S3 may have a convex shape, and the fourth surface S4 may have a concave shape. That is, the second lens 102 may have a meniscus shape convex toward the object side on the optical axis OA. Alternatively, on the optical axis OA, the third surface S3 may have a convex shape, and the fourth surface S4 may have a convex shape. At least one of the third and fourth surfaces S3 and S4 may be an aspherical surface. For example, both the third surface S3 and the fourth surface S4 may be aspheric surfaces. The aspheric coefficients of the third and fourth surfaces S3 and S4 are provided as shown in FIGS. 4 and 10, L2 is the second lens 102, L2S1 is the third surface, and L2S2 is the fourth surface.

The third lens 103 may have positive (+) or negative (−) refractive power on the optical axis OA, and may preferably have positive (+) refractive power. The third lens 103 may include a plastic or glass material. For example, the third lens 103 may be made of a plastic material. The third lens 103 may include a fifth surface S5 defined as an object-side surface and a sixth surface S6 defined as a sensor-side surface. On the optical axis OA, the fifth surface S5 may have a convex shape, and the sixth surface S6 may have a concave shape. That is, the third lens 103 may have a meniscus shape convex toward the object side on the optical axis OA. Alternatively, in the optical axis OA, the fifth surface S5 may have a convex shape, and the sixth surface S6 may have a convex shape. At least one of the fifth surface S5 and the sixth surface S6 may be an aspheric surface. For example, both the fifth surface S5 and the sixth surface S6 may be aspheric surfaces. The aspheric coefficients of the fifth and sixth surfaces S5 and S6 are provided as shown in FIGS. 4 and 10, L3 is the third lens 103, L3S1 is the fifth surface, and L3S2 is the sixth surface.

The first lens group LG1 may include the first to third lenses 101, 102, and 103. Among the first to third lenses 101, 102, and 103, the thickness in the optical axis OA, that is, the center thickness of the lens, the first lens 101 may be the thickest and the second lens 102 may be the thinnest. Accordingly, the optical system 1000 may control incident light and may have improved aberration characteristics and resolving power. Among the first to third lenses 101, 102, and 103, the effective diameter CA (clear aperture) of the third lens may be the smallest and the effective diameter of the first lens 101 may be the largest. In detail, among the first to third lenses 101, 102, and 103, the effective radius r11 (semi-aperture) of the first surface S1 may be the largest, and the effective radius of the sixth surface S6 of the third lens 103 may be the smallest. An effective diameter of the second lens 102 may be smaller than that of the first lens 101 and larger than that of the third lens 103. The effective diameter of the third lens 103 may be the smallest among all lenses of the optical system 1000. The effective diameter is an average value of the effective diameter of the object-side surface of each lens and the effective diameter of the sensor-side surface of each lens. Accordingly, the optical system 1000 may have improved chromatic aberration control characteristics, and may improve vignetting characteristics of the optical system 1000 by controlling incident light.

The refractive index of the second lens 102 may be greater than the refractive index of at least one or both of the first and third lenses 101 and 103. The refractive index of the second lens 102 may be greater than 1.6, for example, 1.65 or greater, and the refractive index of the first and third lenses 101 and 103 may be less than 1.6. The second lens 102 may have an Abbe number smaller than the Abbe numbers of at least one or both of the first and third lenses 101 and 103. For example, the Abbe number of the second lens 102 may be 20 or more smaller than the Abbe number of the first and third lenses 101 and 103, and may be less than 30, for example. In detail, the Abbe number of the first and third lenses 101 and 103 may be 30 or more greater than the Abbe number of the second lens 102. Accordingly, the optical system 1000 may have improved chromatic aberration control characteristics.

When the curvature radius in the optical axis OA is expressed as an absolute value, the curvature radius of the sixth surface S6 of the third lens 103 may be the largest among the first to third lenses 101, 102, and 103, and may be, for example, 10 mm or more. The curvature radius of the first surface S1 of the first lens 101 may be the smallest and may be 7 mm or less. In the first lens group LG1, a difference between a lens surface having a maximum curvature radius and a lens surface having a minimum curvature radius may be 5 times or more. An average curvature radius of the first to sixth surfaces S1 to S6 may be 15 mm or less, for example, in a range of 5 mm to 15 mm. Each of the first to third lenses 101 to 103 may have a meniscus shape convex toward the object side.

The fourth lens 104 may have positive (+) or negative (−) refractive power on the optical axis OA. The fourth lens 104 may have negative (−) refractive power. The fourth lens 104 may include a plastic or glass material. For example, the fourth lens 104 may be made of a plastic material. The fourth lens 104 may include a seventh surface S7 defined as an object-side surface and an eighth surface S8 defined as a sensor-side surface. In the optical axis OA, the seventh surface S7 may have a concave shape, and the eighth surface S8 may have a concave shape. That is, the fourth lens 104 may have a concave shape on both sides of the optical axis OA. Alternatively, the seventh surface S7 may have a concave shape on the optical axis OA, and the eighth surface S8 may have a convex shape on the optical axis OA. That is, the fourth lens 104 may have a meniscus shape convex from the optical axis OA toward the sensor. Alternatively, the fourth lens 104 may have a meniscus shape convex toward the object side on the optical axis OA. At least one of the seventh surface S7 and the eighth surface S8 may be an aspheric surface. For example, both the seventh surface S7 and the eighth surface S8 may be aspheric surfaces. Aspheric coefficients of the seventh and eighth surfaces S7 and S8 are provided as shown in FIGS. 4 and 10, L4 is the fourth lens 104, L4S1 is the seventh surface, and L4S2 is the eighth surface.

When expressed as an absolute value, the curvature radius of the seventh surface S7 of the fourth lens 104 may be the largest in the optical system 1000. When expressed as an absolute value, the focal length of the fourth lens 104 may be the largest in the optical system 1000. The refractive index of the fourth lens 104 may be greater than the refractive index of the first and third lenses 101 and 103. The Abbe number of the fourth lens 104 may be smaller than the Abbe number of the first and third lenses 101 and 103. Accordingly, the optical system 1000 may have improved chromatic aberration control characteristics.

The fifth lens 105 may have positive (+) or negative (−) refractive power on the optical axis OA. The fifth lens 105 may have positive (+) refractive power. The fifth lens 105 may include a plastic or glass material. For example, the fifth lens 105 may be made of a plastic material. When representing an absolute value, the focal length of the fifth lens 105 may be smaller than the focal length of the fourth lens 104, and for example, may satisfy: 20<|F5−F4|<150. The fifth lens 105 may include a ninth surface S9 defined as an object-side surface and a tenth surface S10 defined as a sensor-side surface. The ninth surface S9 may have a convex shape on the optical axis OA, and the tenth surface S10 may have a concave shape on the optical axis OA. That is, the fifth lens 105 may have a meniscus shape convex toward the object side on the optical axis OA. The ninth and tenth surfaces S9 and S10 of the fifth lens 105 may be provided from the optical axis OA to the end of the effective region without a critical point. In addition, the average of the curvature radii of the ninth and tenth surfaces S9 and S10 of the fifth lens 105 is smaller than the curvature radius of the eighth surface S8 of the fourth lens 104 when expressed as an absolute value, and may be 100 mm or less, for example, 50 mm or less. At least one of the ninth surface S9 and the tenth surface S10 may be an aspheric surface. For example, both the ninth surface S9 and the tenth surface S10 may be aspheric surfaces. The aspherical coefficients of the ninth and tenth surfaces S9 and S10 are provided as shown in FIGS. 4 and 10, L5 is the fifth lens 105, L5S1 is the ninth surface, and L5S2 is the tenth surface.

The sixth lens 106 may have positive (+) or negative (−) refractive power on the optical axis OA. The sixth lens 106 may have negative (−) refractive power. The sixth lens 106 may include a plastic or glass material. For example, the sixth lens 106 may be made of a plastic material. The sixth lens 106 may include an eleventh surface S11 defined as an object-side surface and a twelfth surface S12 defined as a sensor-side surface. The eleventh surface S11 may have a convex shape on the optical axis OA, and the twelfth surface S12 may have a concave shape on the optical axis OA. That is, the sixth lens 106 may have a meniscus shape convex toward the object side on the optical axis OA. Alternatively, the eleventh surface S11 may have a concave shape on the optical axis OA, and the twelfth surface S12 may have a convex or concave shape on the optical axis OA. That is, the sixth lens 106 may have a convex meniscus shape toward the sensor or a concave shape on both sides.

When the curvature radius on the optical axis OA is expressed as an absolute value, the average of the curvature radii of the eleventh and twelfth surfaces S12 of the sixth lens 106 may be greater than the average of the curvature radii of the seventh lens 107 and the average of the curvature radii of the eighth lens 108. An average of radii of curvature of the eleventh and twelfth surfaces S12 of the sixth lens 106 may be smaller than an average of radii of curvature of the fifth lens 105. The refractive index of the sixth lens 106 is 1.55 or more, smaller than the refractive index of the second lens 102, and may be greater than the refractive index of the seventh and eighth lenses 107 and 108.

When expressed as an absolute value, the focal length of the sixth lens 106 may be larger than that of the fifth lens 105 and smaller than that of the seventh lens 107. At least one of the eleventh surface S11 and the twelfth surface S12 may be an aspheric surface. For example, both the eleventh surface S11 and the twelfth surface S12 may be aspherical surfaces. Aspheric coefficients of the eleventh and twelfth surfaces S11 and S12 are provided as shown in FIGS. 4 and 10, L6 is the sixth lens 106, L6S1 is the eleventh surface, and L6S2 is the twelfth surface.

From the optical axis OA to the end of the effective radius, the eleventh surface S11 may have at least one critical point, and the twelfth surface S12 may have at least one critical point. Here, when the distance to the critical point of the eleventh surface S11 of the sixth lens 106 based on the optical axis OA is defined as Inf61 and the distance to the critical point of the twelfth surface S12 is defined as Inf62, the following Equation may satisfy: 0<Inf61/Inf62<1. In addition, it may satisfy: Inf61<Inf62, and the Inf61 may be located in the range of 40% or less, for example, 30% to 40%, and the Inf62 may be located in the range of 40% or more, for example, 40% to 50%, based on the distance from the optical axis OA to the end of the effective region.

The seventh lens 107 may have positive (+) or negative (−) refractive power on the optical axis OA. The seventh lens 107 may have positive (+) refractive power. The seventh lens 107 may include a plastic or glass material. For example, the seventh lens 107 may be made of a plastic material. The seventh lens 107 may include a thirteenth surface S13 defined as an object-side surface and a fourteenth surface S14 defined as a sensor-side surface. The thirteenth surface S13 may have a convex shape on the optical axis OA, and the fourteenth surface S14 may have a concave shape on the optical axis OA. That is, the seventh lens 107 may have a meniscus shape convex toward the object side on the optical axis OA. Alternatively, the thirteenth surface S13 may have a concave shape on the optical axis OA or the fourteenth surface S14 may have a convex shape on the optical axis OA, that is, the seventh lens 107 may have a concave shape on both sides of the optical axis OA, a shape on which both sides are convex, or a meniscus shape on which both sides are convex toward the sensor.

As shown in FIG. 2, the thirteenth surface S13 and the fourteenth surface S14 of the seventh lens 107 may have at least one critical point from the optical axis OA to the end of the effective region. The critical point P1 of the thirteenth surface S13 has a distance Inf71 of 49% or less of the effective radius r71, which is the distance from the optical axis OA to the end of the effective radius, for example, in the range of 26% to 46% or in the range of 31% to 41%. The critical point of the fourteenth surface S14 may be located at a distance Inf72 of 35% or more of the effective radius with respect to the optical axis OA, for example, in a range of 35% to 55% or in a range of 40% to 50%. The position of the critical point of the fourteenth surface S14 may be farther from the optical axis OA than the critical point P1 of the thirteenth surface S13. Based on the optical axis, Inf71<Inf72 may be satisfied. Also, the position of Inf62 may be closer to the optical axis than the position of Inf72.

The fourteenth surface S14 may diffuse light incident through the thirteenth surface S13. The critical point is a point at which the sign of the slope value with respect to the optical axis OA and the direction perpendicular to the optical axis OA changes from positive (+) to negative (−) or from negative (−) to positive (+), and may mean a point at which the slope value is zero. Also, the critical point may be a point at which the slope value of a tangent passing through the lens surface decreases as it increases, or a point where the slope value increases as it decreases. The position of the critical point of the seventh lens 107 is preferably disposed at a position that satisfies the above-described range in consideration of the optical characteristics of the optical system 1000. In detail, the position of the critical point preferably satisfies the range described above for controlling optical characteristics such as chromatic aberration, distortion characteristics, aberration characteristics, and resolving power of the optical system 1000. Accordingly, the path of light emitted to the image sensor 300 through the lens may be effectively controlled. Therefore, the optical system 1000 according to the embodiment may have improved optical characteristics even in the center and periphery portions of the FOV. At least one of the thirteenth surface S13 and the fourteenth surface S14 may be an aspherical surface. For example, both the thirteenth surface S13 and the fourteenth surface S14 may be aspheric surfaces. Aspheric coefficients of the thirteenth and fourteenth surfaces S13 and S14 are provided as shown in FIGS. 4 and 10, L7 is the seventh lens 107, L7S1 is the thirteenth surface, and L7S2 is the fourteenth surface.

The eighth lens 108 may have negative (−) refractive power on the optical axis OA. The eighth lens 108 may include a plastic or glass material. For example, the eighth lens 108 may be made of a plastic material. The eighth lens 108 may be the closest lens to the sensor side or may be the last lens in the optical system 1000.

The eighth lens 108 may include a fifteenth surface S15 defined as an object-side surface and a sixteenth surface S16 defined as a sensor-side surface. The fifteenth surface S15 may have a concave shape on the optical axis OA, and the sixteenth surface S16 may have a concave shape on the optical axis OA. That is, the eighth lens 108 may have a concave shape on both sides of the optical axis OA. Alternatively, the eighth lens 108 may have a meniscus shape convex toward the object side on the optical axis or a meniscus shape convex toward the sensor side. The fifteenth and sixteenth surfaces S15 and S16 may be aspherical surfaces. The aspheric coefficients of the fifteenth and sixteenth surfaces S15 and S16 are provided as shown in FIGS. 4 and 10, L8 is the eighth lens 108, L8S1 is the fifteenth surface, and L8S2 is the sixteenth surface.

As shown in FIG. 2, the fifteenth surface S15 of the eighth lens 108 may be provided without a critical point from the optical axis OA to the end of the effective region. The sixteenth surface S16 of the eighth lens 108 may have at least one critical point within a distance r82 from the optical axis OA to the end of the effective region. The critical point P2 of the sixteenth surface S16 is a distance Inf82 of 32% or less of the effective radius r82, which is the distance from the optical axis OA to the end of the effective radius, and may be, for example, in the range of 12% to 32% or in the range of 17% to 27%. The critical point P2 of the fourteenth surface S16 may be located closer to the optical axis OA than the critical point P1 of the thirteenth surface S13. Accordingly, the sixteenth surface S16 may diffuse the light incident through the fifteenth surface S15. Positions of critical points of the sixth, seventh, and eighth lenses 106, 107, and 108 may be located within a range of 0.8 mm to 2.5 mm or 1 mm to 2.3 mm with respect to the optical axis OA. In addition, the normal line K2, which is a straight line perpendicular to the tangent line K1 passing through an arbitrary point on the sensor-side sixteenth surface S16 of the eighth lens 108, which is the last lens, has a predetermined angle θ1 with the optical axis OA, and the maximum angle of the angle θ1 may be greater than 5 degrees and less than 65 degrees, for example, a range of 20 degrees to 50 degrees or a range of 20 degrees to 40 degrees. Accordingly, since the optical axis or paraxial region of the sixteenth surface S16 has a minimum Sag value, a slim optical system may be provided.

Among the fourth to eighth lenses 104, 105, 106, 107, and 108, the lens having the maximum center thickness is the seventh lens 107, and the center thickness of the seventh lens 107 may be greater than the optical axis distance between the sixth and seventh lenses 106 and 107. In the second lens group LG2, the lenses having the minimum center thickness may be the fourth or fifth lenses 104 and 105. Accordingly, the optical system 1000 may control incident light and may have improved aberration characteristics and resolving power.

Among the fourth to eighth lenses 104, 105, 106, 107, and 108, the fourth lens 104 may have the smallest effective diameter (clear aperture: CA) of the lenses, and the eighth lens 108 may have the largest effective diameter (clear aperture: CA). In detail, in the second lens group LG2, the effective diameter of the seventh surface S7 of the fourth lens 104 may be the smallest, and the effective diameter of the sixteenth surface S16 may be the largest. The effective diameter of the sixteenth surface S16 may be the maximum effective diameter in the optical system and may be 2.2 times greater than the effective diameter of the seventh surface S7. The effective diameter of the eighth lens 108 is the largest, so that incident light may be effectively refracted toward the image sensor 300. Accordingly, the optical system 1000 may have improved chromatic aberration control characteristics, and may improve vignetting characteristics of the optical system 1000 by controlling incident light.

In the second lens group LG2, the number of lenses having a refractive index greater than 1.6 may be smaller than the number of lenses having a refractive index of less than 1.6. In the second lens group LG2, the number of lenses having an Abbe number greater than 50 may be smaller than the number of lenses having an Abbe number less than 50.

Referring to FIG. 2, a back focal length (BFL) is an optical axis distance from the image sensor 300 to the last lens. That is, the BFL is the optical axis distance between the image sensor 300 and the sensor-side sixteenth surface S16 of the eighth lens 108. CT7 is the center thickness or optical axis thickness of the seventh lens 107, and L7_ET is the end or edge thickness of the effective region of the seventh lens 107. CT8 is the center thickness or optical axis thickness of the eighth lens 108. CG7 is an optical axis distance (e.g., center distance) from the center of the sensor-side surface of the seventh lens 107 to the center of the object-side surface of the eighth lens 108. That is, the optical axis distance CG7 from the center of the sensor-side surface of the seventh lens 107 to the center of the object-side surface of the eighth lens 108 is a distance between the fourteenth surface S14 and the fifteenth surface S15 in the optical axis OA. The CG7 may be greater than the optical axis distance between the third and fourth lenses 103 and 104. The CG7 may be smaller than the sum of center thicknesses of the seventh and eighth lenses 107 and 108.

The center thickness of the seventh lens 102 is the largest that of the lenses, and the center distance CG7 between the seventh lens 107 and the eighth lens 108 is the maximum among the distances between the lenses. The center thickness of the second lens 102 is the smallest that of the lenses, and the center distance between the first and second lenses 101 and 102 is the smallest among the distances between the lenses. Among the lenses 101 to 108, the maximum center thickness may be 2.5 times or more, for example, in a range of 2.5 times to 5 times the minimum center thickness. Among the plurality of lenses 100, the number of lenses having a center thickness of less than 0.5 mm may be greater than the number of lenses having a center thickness of 0.5 mm or more. Accordingly, the optical system 1000 may be provided with a structure having a slim thickness.

The refractive index of the sixth lens 106 may be greater than that of the seventh and eighth lenses 107 and 108 and may be equal to or greater than 1.6. The sixth lens 106 may have an Abbe number smaller than that of the seventh and eighth lenses 107 and 108. For example, the Abbe number of the sixth lens 106 may be 20 or more smaller than the Abbe number of the eighth lens 108. In detail, the Abbe number of the eighth lens 108 may be 25 or more greater than the Abbe number of the sixth lens 106, for example, 50 or more. Accordingly, the optical system 1000 may have improved chromatic aberration control characteristics.

Among the plurality of lens surfaces S1 to S16, the number of surfaces having an effective radius of less than 2 mm may be smaller than the number of surfaces having an effective radius of 2 mm or more. Describing the curvature radius as an absolute value, the curvature radius of the seventh surface S7 of the fourth lens 104 among the plurality of lenses 100 may be the largest that of the lens surfaces on the optical axis OA, and the curvature radius of the first surface S1 of first lens 101 may be the smallest that of the lens surfaces on the optical axis OA.

Describing the focal length as an absolute value, the focal length of the fourth lens 104 among the plurality of lenses 100 may be the largest among the lenses, and the focal lengths of the fourth and seventh lenses 104 and 107 are greater than or equal to 100 mm. The focal length of any one of the first and eight lenses 101 and 108 may be the smallest and may be 20 mm or less. The maximum focal length may be 10 times or more than the minimum focal length.

The optical system 1000 according to the embodiment disclosed above may satisfy at least one or two or more of equations described below. Accordingly, the optical system 1000 according to the embodiment may have improved optical characteristics. For example, when the optical system 1000 satisfies at least one equation, the optical system 1000 may effectively control aberration characteristics such as chromatic aberration and distortion aberration, and may have good optical performance not only in the center portion of the FOV but also in the periphery portion. The optical system 1000 may have improved resolving power and may have a slimmer and more compact structure.

Hereinafter, the center thicknesses of the first to eighth lenses 101 to 108 may be defined as CT1-CT8, the edge thicknesses may be defined as ET1-ET8, and the optical axis distances between two adjacent lenses may be defined as CG1 to CG8 from the distance between the first and second lenses to the distance between the seventh and eighth lenses, and the edge distances between two adjacent lenses may be defined as EG1 to EG8 from the distance between the first and second lenses to the distance between the seventh and eighth lenses. The unit of the thickness and distance is mm.

$$2 < C T 1 / C T 2 < 4 \qquad [ Equation 1 ]$$

In Equation 1, when the thickness CT1 of the first lens 101 in the optical axis OA and the thickness CT2 of the second lens 102 in the optical axis OA are satisfied, the optical system 1000 may improve aberration characteristics. Preferably, Equation 1 above may satisfy: 3<CT1/CT2<4.

$$1 < C T 3 / E T 3 < 2 \qquad [ Equation 2 ]$$

In Equation 2, when the thickness CT3 in the optical axis of the third lens 103 and the thickness ET3 at the edge of the effective region of the third lens 103 are satisfied, the optical system 1000 may have improved chromatic aberration control characteristics. Preferably, Equation 2 above may satisfy: 1<CT3/ET3<2.

$$1 < C T 1 / E T 1 < 5 \qquad [ Equation 2 - 1 ]$$

$$0 < CT 2 / ET 2 < 1.5 \qquad [ Equation 2 - 2 ]$$

$$( CT 2 + C T 3 ) < CT 1 \qquad [ Equation 2 - 3 ]$$

$$1 \leq CT 4 / ET 4 < 3 \qquad [ Equation 2 - 4 ]$$

$$0.5 < C T 5 / ET 5 < 2.5 \qquad [ Equation 2 - 5 ]$$

$$0 < CT 6 / ET 6 < 1 \qquad [ Equation 2 - 6 ]$$

$$1 < CT 7 / ET 7 < 4 \qquad [ Equation 2 - 7 ]$$

$$1 < CT 8 / ET 8 < 3 \qquad [ Equation 2 - 8 ]$$

$$0.5 < S D / TD < 1 \qquad [ Equation 2 - 9 ]$$

When the ratios of the center thickness to the edge thickness of the second to eighth lenses 102 to 108 in Equations 2-1 to 2-8 are satisfied, the optical system 1000 may have improved chromatic aberration control characteristics. The SD is an optical axis distance from the aperture stop to the sensor-side sixteenth surface S16 of the eighth lens 108, and the TD is an optical axis distance from the object-side first surface S1 of the first lens 101 to the sensor-side sixteenth surface S16 of the eighth lens 108. The aperture stop may be disposed around a sensor-side surface of the second lens 102. When the optical system 1000 according to the embodiment satisfies Equation 2-9, chromatic aberration of the optical system 1000 may be improved.

$$1 < \vert F\_LG2 / F\_LG1 \vert < 10 \qquad [ Equation 2 - 10 ]$$

The F_LG1 is the focal length of the first lens group LG1, and the F_LG2 is the focal length of the second lens group LG2. When the optical system 1000 according to the embodiment satisfies Equation 2-10, chromatic aberration of the optical system 1000 may be improved. That is, as the value of Equation 2-10 approaches 1, the distortion aberration may be reduced. The value of Equation 2-10 may satisfy: 1<|F_LG2/F_LG1|<3.

$$0 < E T 8 / C T 8 < 2 \qquad [ Equation 3 ]$$

In Equation 3, when the thickness CT8 in the optical axis and the thickness ET8 at the edge of the eighth lens 108 are satisfied, the optical system 1000 may have improved chromatic aberration control characteristics. Equation 3 may satisfy: 0.3<ET8/CT8<1.

$$1.6 < n 2 \qquad [ Equation 4 ]$$

In Equation 4, n2 means the refractive index of the second lens 102 at the d-line. When the optical system 1000 according to the embodiment satisfies Equation 4, the optical system 1000 may improve chromatic aberration characteristics.

$$1.5 < n 1 < 1.6 \qquad [ Equation 4 - 1 ]$$

$$1.5 < n 8 < 1.6$$

In Equation 4-1, n1 is the refractive index of the first lens 101 at the d-line, and n8 is the refractive index of the eighth lens 108 at the d-line. When the optical system 1000 according to the embodiment satisfies Equation 4-1, the effect on the TTL of the optical system 1000 may be suppressed.

$$1.6 < n 4 \qquad [ Equation 4 - 2 ]$$

$$1.6 \leq n 6$$

In Equation 4-2, n4 is the refractive index of the fourth lens 104 at the d-line, and n6 is the refractive index of the sixth lens 106 at the d-line. When the optical system 1000 according to the embodiment satisfies Equation 4-2, the optical system 1000 may improve chromatic aberration characteristics.

$$0 \text{.5} < L8S2\_max \_sag to Sensor < 1.5 \qquad [ Equation 5 ]$$

In Equation 5, L8S2_max_sag to Sensor means a distance from the maximum Sag value of the sensor-side sixteenth surface S16 of the eighth lens 108 to the image sensor 300 in a direction of the optical axis. For example, L8S2_max_sag to Sensor means the distance from the critical point P2 of the sensor-side surface of the eighth lens 108 to the image sensor 300 in a direction of the optical axis. When the optical system 1000 according to the embodiment satisfies Equation 5, the optical system 1000 may secure a space in which the optical filter 500 may be disposed between the lens portion 100 and the image sensor 300, thereby having improved assemblability. In addition, when the optical system 1000 satisfies Equation 5, the optical system 1000 may secure a distance for module manufacturing. Preferably, the value of Equation 5 may satisfy: 0.5<L8S2_max_sag to Sensor<1.

In the lens data for the embodiment, the position of the filter 500, in detail, the distance between the last lens and the filter 500, and the distance between the image sensor 300 and the filter 500 are set for convenience in the design of the optical system 1000, and the filter 500 may be freely disposed within a range in which the last lens and the image sensor 300 do not come into contact. Accordingly, the value of the L8S2_max_Sag to Sensor in the lens data may be smaller than the BFL of the optical system 1000, and the position of the filter 500 may move within a range that is not contact the last lens and the image sensor 300, respectively, and have good optical performance. That is, the distance between the threshold point P2 and the image sensor 300 of the sixteenth surface S16 of the eighth lens 108 is minimal, and may gradually increase toward the end of the effective region.

$$1 < B FL / L8S2\_max \_sag to Sensor < 2 \qquad [ Equation 6 ]$$

In Equation 6, BFL means a distance (unit: mm) in the optical axis OA from the center of the sensor-side sixteenth surface S16 of the eighth lens 108 closest to the image sensor 300 to the image surface of the image sensor 300. When the optical system 1000 according to the embodiment satisfies Equation 6, the optical system 1000 may improve distortion aberration characteristics and may have good optical performance in the periphery portion of the FOV. Here, the maximum Sag value may be the position of the critical point. Equation 6 may satisfy: 1.5<BFL/L8S2_max_sag to Sensor<2.

$$5 < \vert L8S2\_max slope \vert < 65 \qquad [ Equation 7 ]$$

In Equation 7, L8S2_max slope means the maximum value (unit: Degree) of the tangential angle measured on the sensor-side sixteenth surface S16 of the eighth lens 108. In detail, in the sixteenth surface S16, the L8S2_max slope means an angle value (unit: Degree) of a point having the largest tangential angle with respect to a virtual line extending in a direction perpendicular to the optical axis OA. When the optical system 1000 according to the embodiment satisfies Equation 7, the optical system 1000 may control the occurrence of lens flare. Preferably, Equation may satisfy: 7 is 20<|L8S2_max slope|<50.

$$1 < Inf 82 < 1.5 \qquad [ Equation 8 ]$$

In Equation 8, Inf82 may mean a distance from the optical axis OA to a critical point (or inflection point) of the sensor-side sixteenth surface S16 of the eighth lens 108. The Inf82 may be located within 1.3 mm±0.2 mm from the optical axis OA. When the optical system 1000 according to the embodiment satisfies Equation 8, the influence on the slim rate of the optical system 1000 may be suppressed.

$$1 < C G 7 / G7\_min < 15 \qquad [ Equation 9 ]$$

Equation 9 refers a minimum interval (unit: mm) between the seventh lens 107 and the eighth lens 108 and the distance between the seventh lens 107 and the eighth lens 108 based on the optical axis OA. When the optical system 1000 according to the embodiment satisfies Equation 9, the optical system 1000 may improve distortion aberration characteristics and may have good optical performance in the periphery portion of the FOV. Equation 9 may satisfy: 5<CG7/G7_min<12 or 8<CG7/G7_min≤10.

$$0 < C G 7 / E G 7 < 2 \qquad [ Equation 10 ]$$

In Equation 10, when the optical axis distance CG7 between the seventh and eighth lenses 107 and 108 and the optical axis distance EG8 at the end of the effective region between the seventh and eighth lenses 107 and 108 are satisfied, it may have good optical performance in the center and periphery portions of the FOV. In addition, the optical system 1000 may reduce distortion and thus have improved optical performance. Preferably, Equation 10 may satisfy: 0.5<CG7/EG7<1.2.

$$0.01 < C G 1 / C G 6 < 1 \qquad [ Equation 11 ]$$

In Equation 11, when the optical axis distance CG1 between the first lens 101 and the second lens 102 and the optical axis distance CG6 between the sixth and seventh lenses 106 and 107 are satisfied, the optical system 1000 may improve aberration characteristics and control the size of the optical system 1000, for example, TTL reduction. Preferably, Equation 11 may satisfy: 0.01<CG1/CG6<0.5.

$$3 < CA\_L8S2 / C G 7 < 20 \qquad [ Equation 11 - 1 ]$$

In Equation 11-1, CA_L8S2 is the effective diameter of the largest lens surface, and is the effective diameter of the sensor-side sixteenth surface S16 of the eighth lens 108. When the optical system 1000 according to the embodiment satisfies Equation 11-1, the optical system 1000 may improve aberration characteristics and control TTL reduction. Preferably, Equation 11-1 may satisfy: 10<CA_L8S2/CG7<15.

$$3 < CA\_L7S2 / C G 7 < 15 \qquad [ Equation 11 - 2 ]$$

Equation 11-2 may set the optical axis distance between the effective diameter CA_L7S2 of the sensor-side fourteenth surface S14 of the seventh lens 107 and the seventh and eighth lenses 107 and 108. When the optical system 1000 according to the embodiment satisfies Equation 11-2, the optical system 1000 may improve aberration characteristics and control TTL reduction. Preferably, Equation 11-2 may satisfy: 5<CA_L7S2/CG7<13.

$$0 < C T 1 / C T 7 < 2 \qquad [ Equation 12 ]$$

In Equation 12, when the thickness CT1 of the first lens 101 in the optical axis OA and the thickness CT7 of the seventh lens 107 in the optical axis OA are satisfied, the optical system 1000 may have improved aberration characteristics. In addition, the optical system 1000 has good optical performance at a set FOV and may control a TTL. Preferably, Equation 12 may satisfy: 0.5<CT1/CT7<1.

$$0 < C T 6 / C T 7 < 3 \qquad [ Equation 13 ]$$

In Equation 13, when the thickness CT6 of the sixth lens 106 in the optical axis OA and the thickness CT7 of the seventh lens 107 in the optical axis are satisfied, the optical system 1000 may alleviate the manufacturing precision of the seventh lens 107 and the eighth lens 108, and may improve optical performance of the center and periphery portions of the FOV. Preferably, Equation 13 may satisfy: 0<CT6/CT7<1. The center thickness of the fifth, sixth, and seventh lenses may satisfy: (CT5+CT6)<CT7. In addition, the center thickness of the first, sixth, seventh, and eighth lenses may satisfy: CT6<CT8<CT1<CT7.

$$0 < L 7 R 2 / L 8 R 1 < 2 \qquad [ Equation 14 ]$$

In Equation 14, L7R2 means the curvature radius (unit: mm) of the fourteenth surface S14 of the seventh lens 107 on the optical axis, and L8R1 means the curvature radius of the fifteenth surface S15 of the eighth lens 108 on the optical axis. When the optical system 1000 according to the embodiment satisfies Equation 14, the aberration characteristics of the optical system 1000 may be improved. Preferably, Equation 14 may satisfy: 0<L7R2/L8R1<1.

$$0 < ( CG 6 - EG 6 ) / ( CG 6 ) < 2 \qquad [ Equation 15 ]$$

When Equation 15 satisfies the center distance CG6 and the edge distance CG7 between the sixth and seventh lenses 106 and 107, the optical system 1000 may reduce distortion and have improved optical performance. When the optical system 1000 according to the embodiment satisfies Equation 15, the optical performance of the center and periphery portions of the FOV may be improved. Equation 15 may preferably satisfy: 0<(CG6−EG6)/(CG6)<1. Here, comparing the center distances CGs between the fourth, fifth, sixth, seventh, and eighth lenses, it may satisfy: CG4<CG6<CG5<CG7.

$$1 < CA\_L1S1 / CA\_L3S1 < 2 \qquad [ Equation 16 ]$$

In Equation 16, CA_L1S1 means the effective diameter (clear aperture: CA) of the first surface S1 of the first lens 101, and CA_L3S1 means the effective diameter of the fifth surface S5 of the third lens 103. When the optical system 1000 according to the embodiment satisfies Equation 16, the optical system 1000 may control light incident to the first lens group LG1 and may have improved aberration control characteristics. Equation 16 may preferably satisfy: 1<CA_L1S1/CA_L3S1<1.5.

$$1 < CA\_L7S2 / CA\_L4S2 < 5 \qquad [ Equation 17 ]$$

In Equation 17, CA_L4S2 means the effective diameter of the eighth surface S8 of the fourth lens 104, and CA_L7S2 means the effective diameter of the fourteenth surface S14 of the seventh lens 107. When the optical system 1000 according to the embodiment satisfies Equation 17, the optical system 1000 may control light incident to the second lens group LG2 and improve aberration characteristics. Preferably, Equation 17 may satisfy: 1<CA_L7S2/CA_L4S2<3.

$$0.5 < CA\_L3S2 / CA\_L4S1 < 1.5 \qquad [ Equation 18 ]$$

In Equation 18, when the effective diameter CA_L3S2 of the sixth surface S6 of the third lens 103 and the effective diameter CA_L4S1 of the seventh surface S7 of the fourth lens 104 are satisfied, the optical system 1000 may improve chromatic aberration and control vignetting for optical performance. Preferably, Equation 18 may satisfy: 0.7<CA_L3S2/CA_L4S1<1.

$$0.1 < CA\_L5S2 / CA\_L7S2 < 1 \qquad [ Equation 19 ]$$

In Equation 19, when the effective diameter CA_L5S2 of the tenth surface S10 of the fifth lens 105 and the effective diameter CA_L7S2 of the fourteenth surface S14 of the seventh lens 107 are satisfied, the optical system 1000 may improve chromatic aberration. Preferably, Equation 19 may satisfy: 0.4≤CA_L5S2/CA_L7S2≤0.7.

$$1 < CA\_L8S 2 / CA\_L1S1 < 5 \qquad [ Equation 20 ]$$

In Equation 20, when the effective diameter CA_L8S1 of the sixteenth surface S16 of the eighth lens 108 and the effective diameter CA_L1S1 of the first surface S1 of the first lens 101 are satisfied, the optical system 1000 may set the FOV and the size of the optical system. Preferably, Equation 20 may satisfy: 2<CA_L8S2/CA_L1S1<3.5.

$$0.8 < CG 3 / EG 3 < 5 \qquad [ Equation 21 ]$$

In Equation 21, when the distance CG3 between the third and fourth lenses 103 and 104 in the optical axis OA and the edge distance EG3 between the third and fourth lenses 103 and 104 are satisfied, the optical system 1000 may reduce chromatic aberration, improve aberration properties, and control vignetting for optical performance. Preferably, Equation 21 may satisfy: 1<CG3/EG3<2.

$$1 < CG 6 / EG 6 < 5 \qquad [ Equation 22 ]$$

In Equation 22, when the center distance CG7 and the edge distance EG7 between the seventh lens 107 and the eighth lens 108 are satisfied, the optical system has good optical performance even in the center and periphery portions of the FOV and may suppress the occurrence of distortion.

At least one of Equations 21 and 22 may further include at least one of Equations 22-1 to 22-5.

$$0 < CG 1 / EG 1 < 1 \qquad [ Equation 22 - 1 ]$$

$$1 < CG 2 / EG 2 < 3 \qquad [ Equation 22 - 2 ]$$

$$0 < CG 4 / EG 4 < 1 \text{.2} \qquad [ Equation 22 - 3 ]$$

$$1 < CG 5 / EG 5 < 10 \qquad [ Equation 22 - 4 ]$$

$$0 < CG 8 / EG 8 < 2 \qquad [ Equation 22 - 5 ]$$

$$0 < G7\_max / CG 7 < 2 \qquad [ Equation 23 ]$$

In Equation 23, G7_Max means the maximum distance among the distances (unit: mm) between the seventh and eighth lenses 107 and 108. When the optical system 1000 according to the embodiment satisfies Equation 23, optical performance may be improved in the periphery portion of the FOV, and distortion of aberration characteristics may be suppressed. Preferably, Equation 23 may satisfy: 0.5<G7_max/CG7<1.5.

$$0 < CT 6 / CG 6 < 2 \qquad [ Equation 24 ]$$

In Equation 24, the thickness CT6 of the sixth lens 106 in the optical axis OA and the distance CG6 between the sixth lens 106 and the seventh lens 107 in the optical axis OA are satisfied. In this case, the optical system 1000 may reduce the effective diameter of the sixth and seventh lenses and the center distance between adjacent lenses, and improve the optical performance of the periphery portion of the FOV. Preferably, Equation 24 may satisfy: 0<CT6/CG6<1.

$$1 < CT 6 / CG 5 < 3 \qquad [ Equation 25 ]$$

In Equation 25, when the thickness CT6 of the sixth lens 106 on the optical axis OA and the distance CG5 between the fifth and sixth lenses 105 and 106 are satisfied, the optical system 1000 may reduce the effective diameters of the fifth and sixth lenses and the distance between the fifth and sixth lenses, and improve the optical performance of the periphery portion of the FOV. Preferably, Equation 25 may satisfy: 1<CT6/CG5<2.

$$0.1 < CT 7 / CG 5 < 1 \qquad [ Equation 26 ]$$

When Equation 26 satisfies the thickness CT7 of the seventh lens 107 in the optical axis OA and the distance CG5 between the fifth and sixth lenses 105 and 106, the optical system 1000 may be reduce the effective diameter of the seventh lenses and the center distance between the fifth and sixth lenses, and improve optical performance of the periphery portion of the FOV. Preferably, Equation 26 may satisfy: 0.1<CT7/CG5<0.8.

$$50 < \vert L 5 R 2 / C T 5 \vert < 400 \qquad [ Equation 27 ]$$

When Equation 27 satisfies the curvature radius L5R2 of the tenth surface S10 of the fifth lens 105 and the thickness CT5 of the fifth lens 105 in the optical axis, the optical system 1000 may control the refractive power of the fifth lens 105, and improve optical performance of light incident to the second lens group LG2. Preferably, Equation 27 may satisfy: 100<|L5R2/CT5|<200.

$$0 < L 5 R 1 / L 7 R 1 < 10 \qquad [ Equation 28 ]$$

When Equation 28 satisfies the curvature radius L5R1 of the ninth surface S9 of the fifth lens 105 and the curvature radius L7R1 of the thirteenth surface S13 of the seventh lens 107, Optical performance may be improved by controlling the shape and refractive power of the fifth and seventh lenses, and the optical performance of the second lens group LG2 may be improved. Preferably, Equation 28 may satisfy: 1<L5R1/L7R1<5.

$$0 < L 1 R 1 / L 1 R 2 < 1 \qquad [ Equation 29 ]$$

Equation 29 may set the curvature radii of the object-side first and second surfaces S1 and S2 of the first lens 101, and when these are satisfied, the lens size and resolving power may be determined. Preferably, Equation 29 may satisfy: 0<L1R1/L1R2<0.5.

$$0 < L 2 R 2 / L 2 R 1 < 1 \qquad [ Equation 30 ]$$

Equation 30 may set the curvature radii of the third and fourth surfaces S3 and S4 of the object side of the second lens 102, and when these are satisfied, the resolving power of the lens may be determined. Preferably, Equation 30 may satisfy: 0<L2R2/L2R1<0.8.

At least one of Equations 28, 29, and 30 may include at least one of Equations 30-1 to 30-6 below, and resolving power of each lens may be determined.

$$0 < L 3 R 1 / L 3 R 2 < 1 \qquad [ Equation 30 - 1 ]$$

$$1 < \vert L 4 R 1 / L 4 R 2 \vert < 5 \qquad [ Equation 30 - 2 ]$$

$$0 < L 5 R 1 / L 5 R 2 < 1 \qquad [ Equation 30 - 3 ]$$

$$1 \leq L 6 R 1 / L 6 R 2 < 3 \qquad [ Equation 30 - 4 ]$$

$$0 < L 7 R 1 / L 7 R 2 < 1. 5 \qquad [ Equation 30 - 5 ]$$

$$0 < \vert L 8 R 2 / L 8 R 1 \vert < 1 \qquad [ Equation 30 - 6 ]$$

$$0 < CT\_Max / CG\_Max < 2 \qquad [ Equation 31 ]$$

In Equation 31, the maximum value of the largest thickness CT_max in the optical axis OA of each of the lenses and the maximum value CG_max of the air gap or distance in the optical axis between the plurality of lenses is satisfied. In this case, the optical system 1000 has good optical performance at the set FOV and focal length, and the size of the optical system 1000 may be reduced, for example, a TTL may be reduced. Preferably, Equation 31 may satisfy: 1<CT_Max/CG_Max<1.5.

$$0 \text{.5} < \sum CT / \sum CG < 2 \qquad [ Equation 32 ]$$

In Equation 32, ECT means the sum of thicknesses (unit: mm) in the optical axis OA of each of the plurality of lenses, and ECG means the sum of the distances (unit: mm) in the optical axis OA between two adjacent lenses of the plurality of lenses. When the optical system 1000 according to the embodiment satisfies Equation 32, the optical system 1000 has good optical performance at the set FOV and focal length, and reduces the size of the optical system 1000, for example, TTL may be reduced. Preferably, Equation 32 may satisfy: 1<ECT/ECG<1.8.

$$10 < \sum Index < 30 \qquad [ Equation 33 ]$$

In Equation 33, ΣIndex means the sum of the refractive indices at the d-line of each of the plurality of lenses. When the optical system 1000 according to the embodiment satisfies Equation 33, the TTL of the optical system 1000 may be controlled and resolving power may be improved. Here, the average refractive index of the first to eighth lenses 101 to 108 may be 1.55 or more. Preferably, Equation 33 may satisfy: 10<ΣIndex<20.

$$10 < \sum Abb / \sum Index < 50 \qquad [ Equation 34 ]$$

In Equation 34, ΣAbbe means the sum of Abbe numbers of each of the plurality of lenses. When the optical system 1000 according to the embodiment satisfies Equation 34, the optical system 1000 may have improved aberration characteristics and resolving power. An average Abbe number of the first to eight lenses 101 to 108 may be 50 or less. Preferably, Equation 34 may satisfy: 10<ΣAbb/ΣIndex<30.

$$0 < \vert Max\_distortion \vert < 5 \qquad [ Equation 35 ]$$

In Equation 35, Max_distortion means the maximum value of distortion in a region from the center (0.0F) to the diagonal end (1.0F) based on the optical characteristics detected by the image sensor 300. When the optical system 1000 according to the embodiment satisfies Equation 35, the optical system 1000 may improve distortion characteristics. Preferably, Equation 35 may satisfy: 1<|Max_distortion|<3.

$$0 < EG\_Max / CT\_Max < 2 \qquad [ Equation 36 ]$$

In Equation 36, CT_max means the thickest thickness (unit: mm) among the thicknesses of each of the plurality of lenses in the optical axis OA, and EG_Max means the maximum edge-side distance between two adjacent lenses. When the optical system 1000 according to the embodiment satisfies Equation 36, the optical system 1000 has a set FOV and focal length, and may have good optical performance in the periphery portion of the FOV. Preferably, Equation 36 may satisfy: 0<EG_Max/CT_Max<1.

$$0.5 < CA\_L1S1 / CA\_min < 2 \qquad [ Equation 37 ]$$

In Equation 37, when the smallest effective diameter CA_Min among the effective diameters CA_L1S1 of the first surface S1 of the first lens 101 and the effective diameters of the first to sixteenth surfaces S1-S16 is satisfied, light incident through the first lens 101 may be controlled, and a slim optical system may be provided while maintaining optical performance. Preferably, Equation 37 may satisfy: 1<CA_L1S1/CA_min<2.

$$1 < CA\_max / CA\_min < 5 \qquad [ Equation 38 ]$$

In Equation 38, CA_max means the largest effective diameter among the object-side and sensor-side surfaces of the plurality of lenses, and means the largest effective diameter among the effective diameters (unit: mm) of the first to sixteenth surfaces S1 to S16. When the optical system 1000 according to the embodiment satisfies Equation 38, the optical system 1000 may provide a slim and compact optical system while maintaining optical performance. Preferably, Equation 38 may satisfy: 2<CA_max/CA_min<4.

$$1 < CA\_max / CA\_Aver < 3 \qquad [ Equation 39 ]$$

In Equation 39, the maximum effective diameter CA_max and the average effective diameter CA_Aver of the object-side surfaces and sensor-side surfaces of the plurality of lenses are set, and when these are satisfied, a slim and compact optical system may be provided. Preferably, Equation 39 may satisfy: 1.5<CA_max/CA_AVR<2.5.

$$0.1 < CA\_min / CA\_Aver < 1 \qquad [ Equation 40 ]$$

In Equation 40, the smallest effective diameter CA_min and the average effective diameter CA_Aver of the object-side surfaces and the sensor-side surfaces of the plurality of lenses may be set, and when these are satisfied, a slim and compact optical system may be provided. Preferably, Equation 40 may satisfy: 0.1<CA_min/CA_AVR<0.8.

$$0.1 < CA\_max / ( 2 \times ImgH ) < 1 \qquad [ Equation 41 ]$$

In Equation 41, the largest effective diameter CA_max among the object-side surfaces and the sensor-side surfaces of the plurality of lenses and the distance ImgH from the center (0.0F) to the diagonal end (1.0F) of the image sensor 300 are set, when this is satisfied, the optical system 1000 has good optical performance in the center and periphery portions of the FOV and provides a slim and compact optical system. Here, the ImgH may be in the range of 4 mm to 10 mm. Preferably, Equation 41 may satisfy: 0.5<CA_max/(2*ImgH)<1.

$$0.1 < TD / CA\_max < 1.5 \qquad [ Equation 42 ]$$

In Equation 42, TD is the maximum optical axis distance (unit: mm) from the object-side surface of the first lens group LG1 to the sensor-side surface of the second lens group LG2. For example, it is the distance from the first surface S1 of the first lens 101 to the sixteenth surface S16 of the eighth lens 108 in the optical axis OA. When the optical system 1000 according to the embodiment satisfies Equation 42, a slim and compact optical system may be provided. Preferably, Equation 42 may satisfy: 0.5<TD/CA_max<1.

$$0 < F / L 7 R 2 < 5 \qquad [ Equation 43 ]$$

In Equation 43, it is possible to set the total effective focal length F of the optical system 1000 and the curvature radius L7R2 of the fourteenth surface S14 of the seventh lens 107. When these are satisfied, the optical system 1000 may reduce the size of the optical system 1000, for example, the TTL. Preferably, Equation 43 may satisfy: 1<F/L7R2<3.

Equation 43 may further include Equation 43-1 below.

$$1 < F / F \# < 6 \qquad [ Equation 43 - 1 ]$$

The F# may mean an F number. Preferably, Equation 43-1 may satisfy: 2<F/F#<5.

$$0 < F / L 8 R 2 < 1 \qquad [ Equation 43 - 2 ]$$

Equation 43-2 may set the total effective focal length F of the optical system 1000 and the curvature radius L8R2 of the sixteenth surface S16 of the eighth lens 108. Preferably, Equation 43-2 may satisfy: 0<F/L8R2<0.5.

$$1 < F / L 1 R 1 < 10 \qquad [ Equation 44 ]$$

In Equation 44, the curvature radius L1R1 and the total effective focal length F of the first surface S1 of the first lens 101 may be set, and when they are satisfied, the optical system 1000 1000 may be reduced in size, for example, TTL may be reduced. Preferably, Equation 44 may satisfy: 1<F/L1R1<5.

$$0 < EPD / L 8 R 2 < 5 \qquad [ Equation 45 ]$$

In Equation 45, EPD means the entrance pupil diameter (unit: mm) of the optical system 1000, and L8R2 means the curvature radius (unit: mm) of the sixteenth surface S16 of the eighth lens 108. When the optical system 1000 according to the embodiment satisfies Equation 45, the optical system 1000 may control overall brightness and may have good optical performance in the center and periphery portions of the FOV. Preferably, Equation 45 may satisfy: 0<EPD/L8R2<1.

Equation 45 may further include Equation 45-1 below.

$$1 < EPD / F \# < 3 \qquad [ Equation 45 - 1 ]$$

$$0.5 < EPD / L 1 R 1 < 8 \qquad [ Equation 46 ]$$

Equation 46 means the relationship between the EPD of the optical system and the curvature radius of the first surface S1 of the first lens 101, and may control incident light. Preferably, Equation 46 may satisfy: 0.5<EPD/L1R1<2.

$$- 5 < F 1 / F 2 < 0 \qquad [ Equation 47 ]$$

In Equation 47, the focal lengths F1 and F2 of the first and second lenses 101 and 102 may be set. Accordingly, resolving power may be improved by adjusting the refractive power of the incident light of the first and second lenses 101 and 102, and TTL may be controlled. Preferably, Equation 47 may satisfy: −1<F1/F2<0.

$$1 < F 12 / F < 5 \qquad [ Equation 48 ]$$

By setting the composite focal length F12 and the total focal length F of the first and second lenses in Equation 48, the optical system 1000 may improve resolving power by adjusting the refractive power of incident light, and the optical system 1000 may control the TTL. Preferably, Equation 48 may satisfy: 1<F12/F<3.

$$1 < \vert F 48 / F 13 \vert < 4 \qquad [ Equation 49 ]$$

In Equation 49, the composite focal length F13 of the first to third lenses, that is, the focal length (unit: mm) of the first lens group and the composite focal length F48 of the fourth to eighth lenses, that is, the focal length of the second lens group may be set, and when this is satisfied, resolving power may be improved by controlling the refractive power of the first lens group and the refractive power of the second lens group, and the optical system may be provided in a slim and compact size. In addition, when Equation 49 is satisfied, the optical system 1000 may improve aberration characteristics such as chromatic aberration and distortion aberration. The above Equation 49 may preferably satisfy: 1<|F48/F13|<2. Here, F13>0 and F48<0 may be satisfied.

In addition, the following Equation may satisfy: F12>F13.

$$0 < F 1 / F < 3 \qquad [ Equation 50 ]$$

In Equation 50, the total focal length F and the refractive power of the first lens 101 may be set, and the resolving power may be improved. Equation 50 may satisfy: 0<F1/F<2.

$$0 < \vert F 2 / F \vert < 5 ( where F > 0 , F 2 < 0 ) \qquad [ Equation 50 - 1 ]$$

$$0 < F 3 / F 2 < 5 ( where F 3 > 0 ) \qquad [ Equation 50 - 2 ]$$

$$5 < \vert F 4 / F \vert < 25 ( where F 4 < 0 ) \qquad [ Equation 50 - 3 ]$$

$$0 < F 5 / F < 10 ( where F 5 > 0 ) \qquad [ Equation 50 - 4 ]$$

$$1 < \vert F 6 / F \vert < 15 ( where F 6 < 0 ) \qquad [ Equation 50 - 5 ]$$

$$5 < F 7 / F < 25 ( where F 7 > 0 ) \qquad [ Equation 50 - 6 ]$$

$$0 < \vert F 8 / F \vert < 5 ( where F8 < 0 ) \qquad [ Equation 50 - 7 ]$$

In Equations 50-1 to 50-7, F3, F4, F5, F6, F7, and F8 refer to the focal length (unit: mm) of the third, fourth, fifth, sixth, seventh, and eighth lenses 103, 104, 105, 106, 107, and 108, and when this is satisfied, the resolving power may be improved by controlling the refractive power of each lens, and the optical system may be provided in a slim and compact size.

$$0 < F 1 / F 13 < 2 \qquad [ Equation 51 ]$$

The resolving power of the first lens group may be adjusted by setting the focal length F1 of the first lens and the composite focal length F13 of the first to third lenses in Equation 51. Preferably, Equation 51 may satisfy: 0<F1/F13<1.5.

$$0 < F 1 / \vert F 48 \vert < 2 \qquad [ Equation 52 ]$$

In Equation 52, by setting the focal length F1 of the first lens and the composite focal length F48 of the fourth to eighth lenses, the size and resolving power of the optical system may be adjusted. Preferably, Equation 52 may satisfy: 0<F1/|F48|<1.

Here, when the aperture stop is disposed on the circumferential surface of the sensor side of the second lens, the composite focal length of the first and second lenses is F12 based on the position of the aperture stop, the composite focal length from the third lens to the eighth lens is F38, and the following Equations may satisfy: F12>F13, and |F38|>|F48|.

$$0 < \vert F 1 / F 4 \vert < 1 \qquad [ Equation 53 ]$$

By setting the focal length F1 of the first lens and the focal length F4 of the fourth lens in Equation 53, the refractive power of light incident to the first and second lens groups may be controlled, and the size and resolving power of the optical system may be adjusted. Preferably, Equation 53 may satisfy: 0<F1/|F4|<0.5.

$$2 mm < TTL < 20 mm \qquad [ Equation 54 ]$$

In Equation 54, TTL means the distance (unit: mm) in the optical axis OA from the apex of the first surface S1 of the first lens 101 to the image surface of the image sensor 300. Preferably, Equation 54 may satisfy: 5 mm<TTL<15 mm, and thus a slim and compact optical system may be provided.

$$2 mm < ImgH \qquad [ Equation 55 ]$$

Equation 55 sets the diagonal length (2*ImgH) of the image sensor 300 to exceed 4 mm, thereby providing an optical system with high resolving power. Equation 55 may preferably satisfy: 4 mm≤ImgH<12 mm.

$$BFL < 2.5 \qquad [ Equation 56 ]$$

In Equation 56, BFL (Back focal length) is less than 2.5 mm, so that the installation space of the filter 500 may be secured and the assembly of the components is improved through the gap between the image sensor 300 and the last lens and improve coupling reliability. Equation 56 may preferably satisfy: 0<BFL<1.2 mm.

$$2 mm < F < 20 mm \qquad [ Equation 57 ]$$

In Equation 57, the total focal length F may be set according to the optical system, and preferably, may satisfy: 5 mm<F<15 mm.

$$FOV < 120 degrees \qquad [ Equation 58 ]$$

In Equation 58, a FOV means a FOV of the optical system 1000, and an optical system of less than 120 degrees may be provided. The FOV may be greater than 70 degrees, for example, in the range of 70 degrees to 100 degrees.

$$0.5 < T T L / CA\_max < 2 \qquad [ Equation 59 ]$$

In Equation 59, a slim and compact optical system may be provided by setting the largest effective diameter CA_max among the object-side and sensor-side surfaces of the plurality of lenses and TTL. Preferably, Equation 59 may satisfy: 0.5<TTL/CA_max<1.

$$0.5 < TTL / ImgH < 3 \qquad [ Equation 60 ]$$

Equation 60 may set the total optical axis length (TTL) of the optical system and the diagonal length (ImgH) from the optical axis in the image sensor 300. When the optical system 1000 according to the embodiment satisfies Equation 60, the optical system 1000 secures a BFL for the application of a relatively large-sized image sensor 300, for example, a large-sized image sensor 300 around 1 inch, and may have a smaller TTL and may have a high-definition implementation and a slim structure. Preferably, Equation 60 may satisfy: 0.8<TTL/ImgH<2.

$$0.01 < BFL / ImgH < 0.5 \qquad [ Equation 61 ]$$

Equation 61 may set the distance between the optical axis between the image sensor 300 and the last lens and the length in the diagonal direction from the optical axis of the image sensor 300. When the optical system 1000 according to the embodiment satisfies Equation 61, the optical system 1000 applies a relatively large image sensor 300, for example, a large image sensor 300 around 1 inch. It is possible to secure a back focal length (BFL) for the image sensor 300, and it is possible to minimize the distance between the last lens and the image sensor 300, so that good optical characteristics may be obtained at the center and periphery portions of the FOV. Preferably, Equation 61 may satisfy: 0.1≤BFL/ImgH≤0.3.

$$4 < TTL / BFL < 10 \qquad [ Equation 62 ]$$

Equation 62 may set (unit, mm) the total optical axis length TTL of the optical system and the optical axis distance BFL between the image sensor 300 and the last lens. When the optical system 1000 according to the embodiment satisfies Equation 62, the optical system 1000 secures the BFL and may be provided slim and compact. Equation 62 may satisfy: 6<TTL/BFL<10.

$$0.5 < F / TTL < 1.5 \qquad [ Equation 63 ]$$

Equation 63 may set the total focal length F and total optical axis length TTL of the optical system 1000. Accordingly, a slim and compact optical system may be provided. Equation 63 may preferably satisfy: 0.5<F/TTL<1.2.

$$0 < F \# / TTL < 0.5 \qquad [ Equation 63 - 1 ]$$

Equation 63-1 may set the F number (F#) and the total optical axis length TTL of the optical system 1000. Accordingly, a slim and compact optical system may be provided.

$$3 < F / BFL < 10 \qquad [ Equation 64 ]$$

Equation 64 may set (unit, mm) the total focal length F of the optical system 1000 and the optical axis distance BFL between the image sensor 300 and the last lens. When the optical system 1000 according to the embodiment satisfies Equation 64, the optical system 1000 may have a set FOV, may have an appropriate focal length, and may provide a slim and compact optical system. In addition, the optical system 1000 may minimize the distance between the last lens and the image sensor 300, so that it may have good optical characteristics in the periphery portion of the FOV. Preferably, Equation 64 may satisfy: 5<F/BFL<10.

$$0.1 < F / ImgH < 3 \qquad [ Equation 65 ]$$

Equation 65 may set the total focal length F (unit: mm) of the optical system 1000 and the diagonal length (ImgH) from the optical axis of the image sensor 300. The optical system 1000 may have improved aberration characteristics by applying a relatively large image sensor 300, for example, a large image sensor 300 of around 1 inch. Preferably, Equation 65 may satisfy: 0.8<F/ImgH<2.

$$1 < F / EPD < 5 \qquad [ Equation 66 ]$$

Equation 66 may set the total focal length F (unit: mm) of the optical system 1000 and the entrance pupil diameter. Accordingly, the overall brightness of the optical system may be controlled. Preferably, Equation 66 may satisfy: 1.5<F/EPD<4.

$$0 < BFL / TD < 0.3 \qquad [ Equation 67 ]$$

In Equation 67, the optical axis distance BFL between the image sensor 300 and the last lens and the optical axis distance TD of the lenses are set, and when these are satisfied, the optical system 1000 may provide a slim and compact optical system. Preferably, Equation 67 may satisfy: 0<BFL/TD≤0.2. When BFL/TD exceeds 0.3, the size of the entire optical system increases because the BFL compared to TD is designed to be large, which makes it difficult to miniaturize the optical system, and since the distance between the eleventh lens and the image sensor increases, the amount of unnecessary light may increase through the eleventh lens and the image sensor, and as a result, there is problem in that resolving power is lowed, such as deterioration in aberration characteristics.

$$0 < EPD / ImgH / FOV < 0.2 \qquad [ Equation 68 ]$$

In Equation 68, the relationship between the size of the EPD, the length ImgH of ½ of the maximum diagonal length of the image sensor, and the FOV may be set. Accordingly, the overall size and brightness of the optical system may be controlled. Equation 68 may preferably satisfy: 0<EPD/ImgH/FOV<0.1.

$$5 < FOV / F \# < 50 \qquad [ Equation 69 ]$$

Equation 69 may establish a relationship between the FOV of the optical system and the F number. Equation 69 may preferably satisfy: 30<FOV/F#<50.

$$0 < n 1 / n 2 < 1.5 \qquad [ Equation 70 ]$$

When the refractive indices n1 and n2 of the first and second lenses 101 and 102 of Equation 70 at the d-line satisfy the above range, the optical system may improve the resolving power of the incident light. Preferably, Equation 70 may satisfy: 0<n1/n2<1.

$$0 < n 3 / n 4 < 1.5 \qquad [ Equation 71 ]$$

When the refractive indices n3 and n4 of the third and fourth lenses 103 and 104 of Equation 71 at the d-line satisfy the above range, the optical system may improve resolving power of the incident light of the second lens group LG2. Preferably, Equation 71 may satisfy: 0<n3/n4<1.

$$0 < Inf 61 / Inf 62 < 1 \qquad [ Equation 72 ]$$

In Equation 72, the distance (Inf61) from the optical axis OA to the critical point of the object-side surface S11 of the sixth lens 106 and the distance (Inf62) from the optical axis OA to the critical point of the sensor-side surface S12 may be set, and when this is satisfied, the satisfactory aberration of the sixth lens may be controlled. Equation 72 may satisfy: 0.5<Inf61/Inf62<1.

$$0 < Inf 61 / InF 72 < 1 \qquad [ Equation 73 ]$$

In Equation 73, the distance (Inf61) from the optical axis OA to the critical point of the object-side surface S11 of the sixth lens 106 and the distance (Inf72) from the optical axis OA to the critical point of the sensor-side surface S14 of the seventh lens 107 may be set, and when this is satisfied, the satisfactory aberrations of the sixth and seventh lenses may be controlled. Equation 73 may satisfy: 0.3<Inf61/Inf72<0.8.

$$0 < Inf 62 / Inf 72 < 1 \qquad [ Equation 74 ]$$

In Equation 74, the distance (Inf62) from the optical axis OA to the critical point of the sensor-side surface S12 of the sixth lens 106 and the distance (Inf72) from the optical axis OA to the critical point of the sensor-side surface S14 of the seventh lens 107 may be set, and when this is satisfied, the satisfactory aberrations of the sixth and seventh lenses may be controlled. Equation 74 may satisfy: 0.5<Inf62/Inf72<1.

$$0 < Inf 61 / semi - Aperture\_L 6 S 1 < 1 \qquad [ Equation 75 ]$$

In Equation 75, the distance (Inf61) from the optical axis OA to the critical point of the object-side surface S11 of the sixth lens 106 and the effective radius (semi-Aperture_L6S1) of the object-side surface of the sixth lens 106 may be set, and when this is satisfied, the satisfactory aberration of the object-side surface of the sixth lens may be controlled. Equation 75 may satisfy: 0.2<Inf61/semi-Aperture_L6S1<0.8.

$$0 < Inf 61 / semi - Aperture\_L 6 S 2 < 1 \qquad [ Equation 76 ]$$

In Equation 76, the distance (Inf62) from the optical axis OA to the critical point of the sensor-side surface S12 of the sixth lens 106 and the effective radius (semi-Aperture_L6S2) of the sensor-side surface of the sixth lens 106 may be set, and when this is satisfied, the satisfactory aberration of the sensor-side surface of the sixth lens may be controlled. Equation 76 may satisfy: 0.1<Inf62/semi-Aperture_L6S2<0.7.

$$0 < Inf 71 / semi - Aperture\_L 7 S 1 < 0. 9 \qquad [ Equation 77 ]$$

In Equation 77, the distance (Inf71) from the optical axis OA to the critical point of the object-side surface S13 of the seventh lens 107 and the effective radius (semi-Aperture_L7S1) of the object-side surface of the seventh lens 107 may be set, and when this is satisfied, the satisfactory aberration of the object-side surface of the seventh lens may be controlled. Equation 77 may satisfy: 0<Inf71/semi-Aperture_L7S1<0.5.

$$0 < Inf 72 / semi - Aperture\_L7S2 < 0.9 \qquad [ Equation 78 ]$$

In Equation 78, the distance (Inf72) from the optical axis OA to the critical point of the sensor-side surface S14 of the seventh lens 107 and the effective radius (semi-Aperture_L7S2) of the sensor-side surface of the seventh lens 106 may be set, and when this is satisfied, the satisfactory aberration of the sensor-side surface of the seventh lens may be controlled. Equation 78 may satisfy: 0<Inf72/semi-Aperture_L7S2<0.7.

$$0 < \vert Max\_Sag71 \vert / semi - Aperture\_L7S1 < 0.8 \qquad [ Equation 79 ]$$

In Equation 79, the maximum height Max_Sag71 of the thirteenth surface S13 from a straight line orthogonal to the center of the object-side thirteenth surface S13 of the seventh lens 107 and the effective radius of the thirteenth surface S13 may be set, when this is satisfied, the satisfactory aberration of the thirteenth surface of the seventh lens may be controlled. Preferably, Equation 79 may satisfy: 0<|Max_Sag71|/semi-Aperture_L7S1<0.5.

$$0 < \vert Max\_Sag72 \vert / semi - Aperture\_L7S2 < 0. 8 \qquad [ Equation 80 ]$$

In Equation 80, the maximum height Max_Sag72 of the fourteenth surface S14 from a straight line orthogonal to the center of the sensor-side fourteenth surface S14 of the seventh lens 107 and the effective radius of the fourteenth surface S14 are set, when this is satisfied, the satisfactory aberration of the fourteenth surface of the seventh lens may be controlled. Preferably, Equation 80 may satisfy: 0<|Max_Sag72|/semi-Aperture_L7S2<0.6.

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + … \qquad [ Equation 81 ]$$

In Equation 81, Z is Sag, and may mean a distance in the optical axis direction from an arbitrary position on the aspheric surface to the apex of the aspheric surface. The Y may mean a distance in a direction perpendicular to the optical axis from an arbitrary position on the aspheric surface to the optical axis. The c may mean the curvature of the lens, and K may mean the conic constant. Also, A, B, C, D, E, and F may mean aspheric constants.

The optical system 1000 according to the embodiment may satisfy at least one or two or more of Equations 1 to 80. In this case, the optical system 1000 may have improved optical characteristics. In detail, when the optical system 1000 satisfies at least one or two or more of Equations 1 to 80, the optical system 1000 has improved resolving power and may improve aberration and distortion characteristics. In addition, the optical system 1000 may secure a BFL (Back focal length) for applying the large-size image sensor 300, and may minimize the distance between the last lens and the image sensor 300 and thus have good optical performance in the center and periphery portions of the FOV. In addition, when the optical system 1000 satisfies at least one of Equations 1 to 70, it may include a relatively large image sensor 300, have a relatively small TTL value, and may provide a slimmer and more compact optical system and a camera module having the same.

In the optical system 1000 according to the embodiment, the distance between the plurality of lenses 100 may have a value set according to the region.

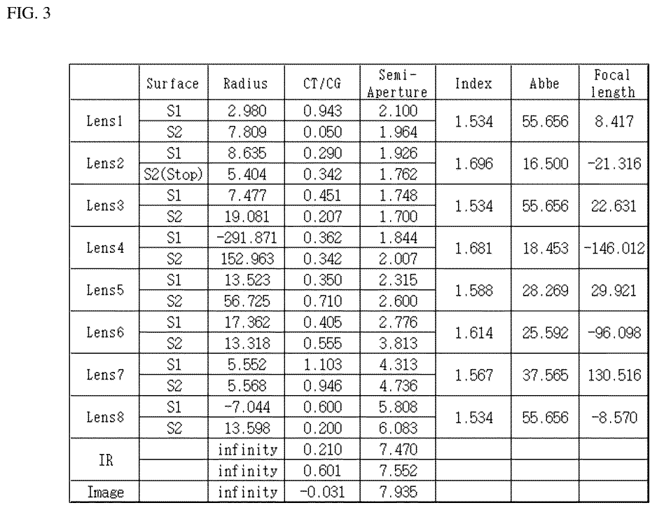

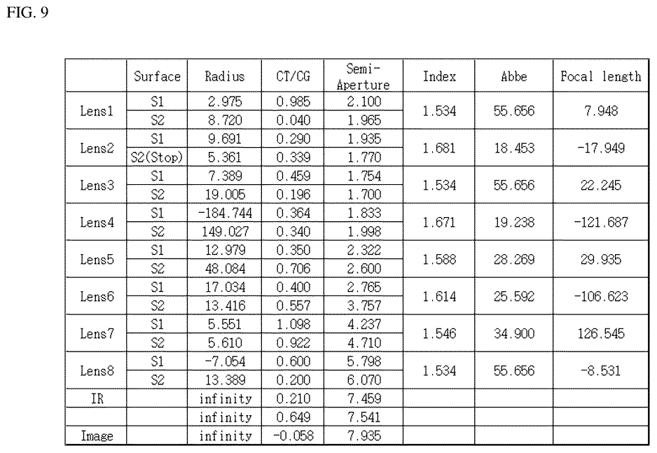

FIG. 3 is an example of lens data according to the first embodiment having the optical system of FIG. 1, and FIG. 9 is an example of lens data according to the second embodiment having the optical system of FIG. 1.

As shown in FIGS. 3 and 9, the optical system according to the embodiment represents the curvature radius of the first to eighth lenses 101 to 108 on the optical axis OA, the center thickness CT of the lens, and the center distances CG between the lenses, refractive index at d-line (588 nm), Abbe number and effective radius (Semi-aperture), and focal length.

The sum of the refractive indices of the plurality of lenses 100 is greater than 10, the sum of the Abbe numbers is greater than 200, the sum of the center thicknesses of all lenses is 5 mm or less, for example, in the range of 3.5 mm to 5 mm, and a sum of center distances between the first to eighth lenses in the optical axis may be 4 mm or less, for example, in a range of 2 mm to 4 mm, and may be greater than the sum of center thicknesses of the lenses. In addition, the average value of the effective diameter of each lens surface of the plurality of lenses 100 may be 4 mm or more, for example, in the range of 4 mm to 6.5 mm, and the average of the center thickness of each lens may be 0.8 mm or less, for example, in the range of 0.35 mm to 0.8 mm. The sum of the effective diameters of the plurality of lenses 100 is a sum of the effective diameters from the first surface S1 to the sixteenth surface S16, and may be 70 mm or more, for example, 70 mm to 110 mm.

In the absolute value of the focal length, the focal length of the fourth lens 104 is the maximum, the focal length of any one of the first and eighth lenses 101 and 108 is the minimum, and may be disposed smaller than the focal length of the second and third lenses.

As shown in FIGS. 4 and 10, the lens surfaces of at least one or all of the plurality of lenses in the first and second embodiments may include an aspheric surface having a 30th order aspheric coefficient. For example, the first to eighth lenses 101, 102, 103, 104, 105, 106, 107, and 108 may include lens surfaces having 30th order aspheric coefficients from the first surface S1 to the sixteenth surface S16. As described above, an aspherical surface having a 30th order aspherical surface coefficient (a value other than “0”) may change the aspheric shape of the periphery particularly greatly, so that the optical performance of the periphery portion of the FOV may be well corrected.

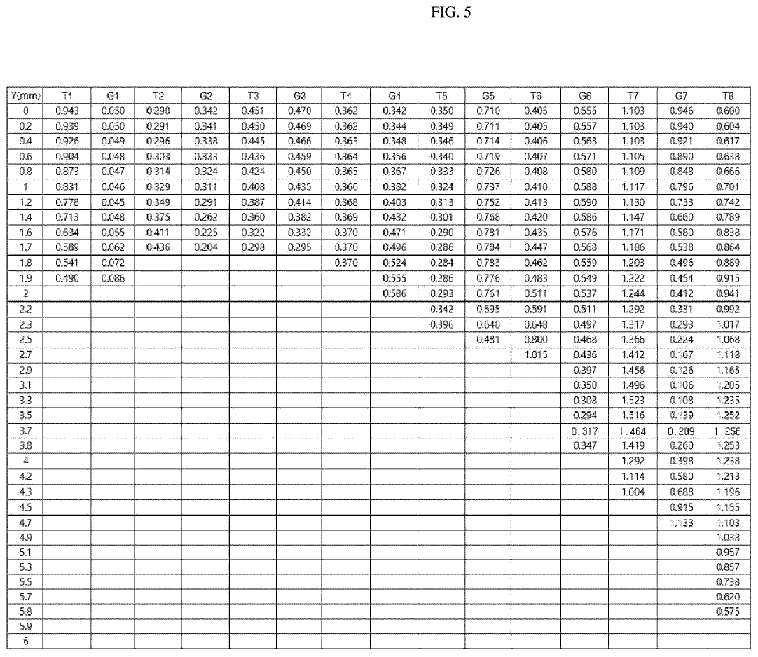

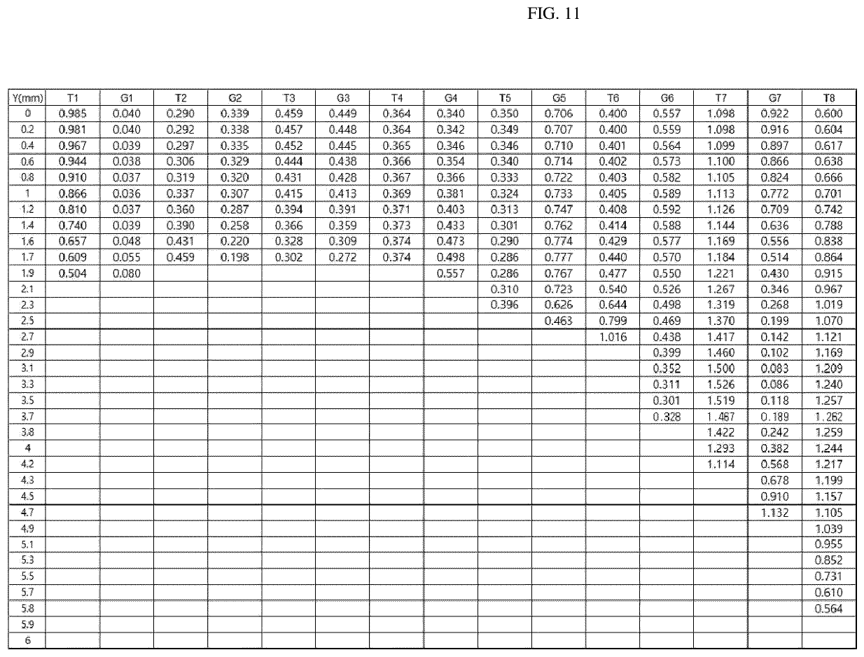

As shown in FIGS. 5 and 11, the first to eighth thicknesses T1 to T8 of the first to eighth lenses 101 to 108 may be represented at distances of 0.1 mm or more in a direction Y from the center to the edge of each lens, the distance between adjacent lenses may be expressed at distances of 0.1 mm or more in a direction from the center to the edge with respect to a first distance G1 between the first and second lenses, a second distance G2 between the second and third lenses, a third distance G3 between the third and fourth lenses, a fourth distance G4 between the fourth and fifth lenses, a fifth distance G5 between the fifth and sixth lenses, a sixth distance G6 between the sixth and seventh lenses, a seventh distance G7 between the seventh and eighth lenses.

The maximum thickness of the first thickness T1 may be 1.6 times or more, for example, 1.6 times to 2.6 times the minimum thickness. The maximum distance of the first distance G1 may be of 1.3 times or more, for example, 1.3 times to 2.3 times greater than the minimum distance. The maximum thickness of the second thickness T2 may be 1.1 times or more, for example, 1.1 times to 2.1 times the minimum thickness. The maximum distance of the second distance G2 may be 1.1 times or more, for example, 1.1 times to 2.1 times the minimum distance. The maximum thickness of the third thickness T3 may be 1.1 times or more, for example, 1.1 times to 2.1 times the minimum thickness. The maximum distance of the third distance G3 may be 1.1 times or more, for example, 1.1 times to 2.1 times greater than the minimum distance. A difference between the maximum thickness and the minimum thickness of the fourth thickness T4 may be 10% or less. The maximum distance of the fourth distance G4 may be 1.2 times or more, for example, 1.2 times to 2.2 times the minimum distance. The maximum thickness of the fifth thickness T5 may be one or more times, for example, one to two times the minimum thickness. The maximum distance of the fifth distance G5 may be 1.1 times or more, for example, 1.1 times to 2.1 times greater than the minimum distance. The maximum thickness of the sixth thickness T6 may be 2.1 times or more, for example, 2.1 times to 3.1 times the minimum thickness. The maximum distance of the sixth distance G6 may be 1.5 times or more, for example, 1.5 times to 2.5 times the minimum distance. The maximum thickness of the seventh thickness T7 may be 1.1 times or more, for example, 1.1 times to 2.1 times the minimum thickness. The maximum distance of the seventh distance G7 may be 5 times or more, for example, 5 times to 15 times greater than the minimum distance. The maximum thickness of the eighth thickness T8 may be 1.6 times or more, for example, 1.6 times to 2.6 times the minimum thickness. The optical system may be provided in a slim and compact size by using the first to eighth thicknesses T1 to T8 and the first to seventh distances G1 to G7.

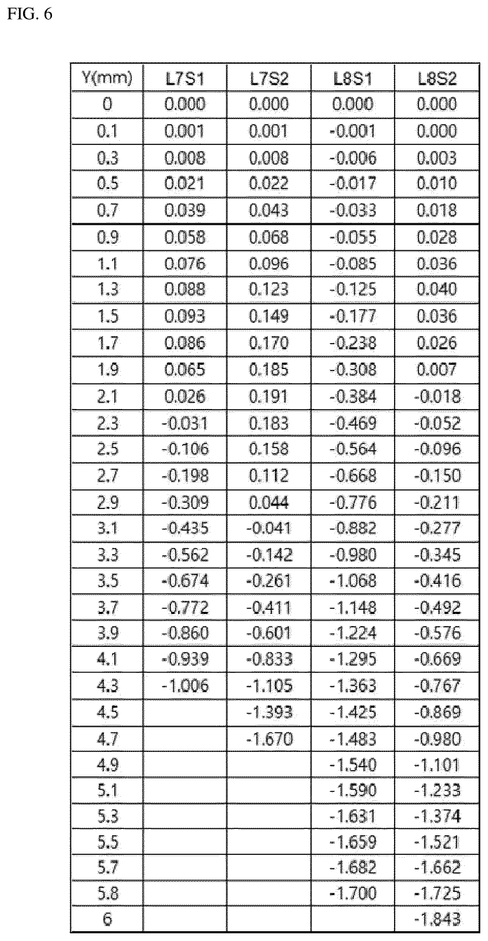

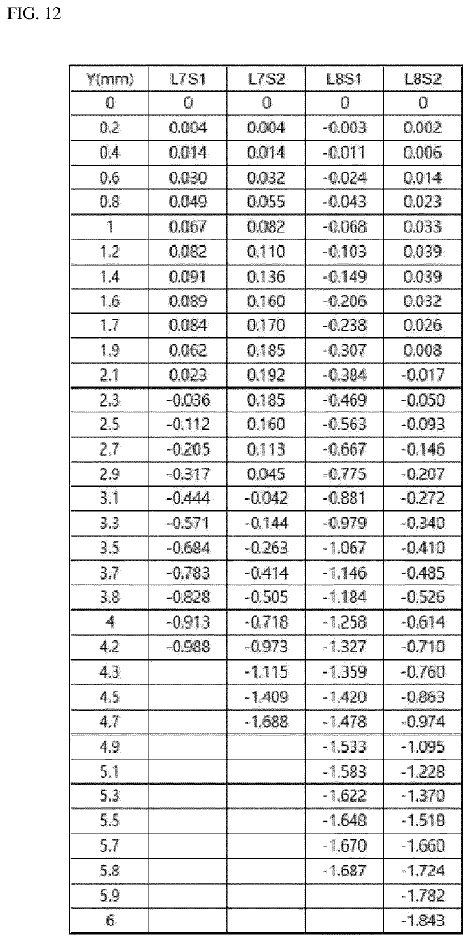

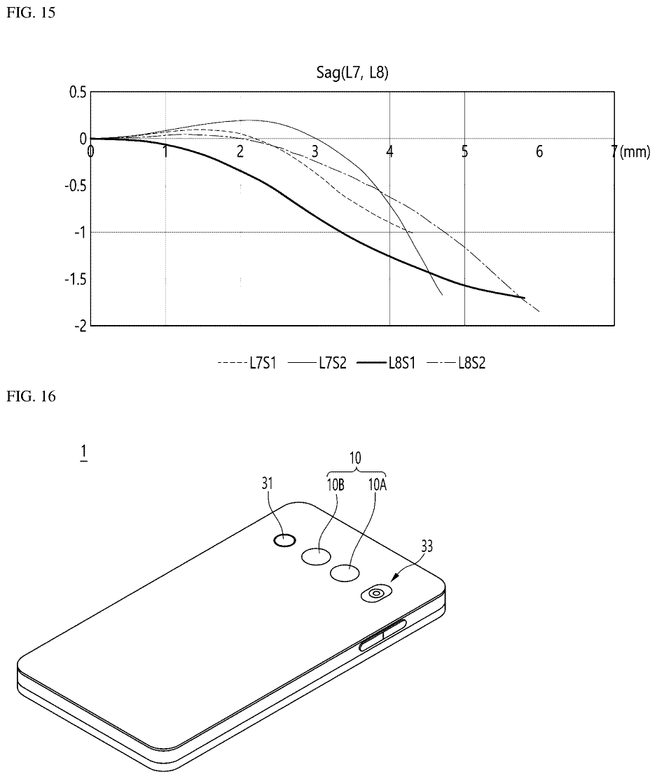

FIGS. 6 and 12 may be represented by a height (Sag value) from a straight line in the Y-axis direction orthogonal to the center of an object-side surface L7S1 and a sensor-side surface L7S2 of a seventh lens 107, an object-side surface L8S1 and a sensor-side surface L8S2 of an eighth lens 108 according to an embodiment of the invention to a lens surface at distances of 0.1 mm or more, and FIG. 15 is a graph showing FIGS. 6 and 12. As shown in FIGS. 6, 12, and 15, the object-side surface L7S1 and the sensor-side surface L7S2 of the seventh lens 107 have a critical point at 3 mm or less from the optical axis, and the critical point (see FIG. 2 P1) of the object-side surface appears closer to the optical axis than the critical point on the sensor-side surface, and it may be seen that the Sag value of L7S2 appears larger than that of L7S1 toward the sensor side. In addition, the object-side surface of the eighth lens may be provided without a critical point, and the sensor-side surface of the eighth lens has a critical point that is smaller than the sensor-side Sag values of L7S1 and L7S2 and may have a critical point (see P2 in FIG. 2) closer to the optical axis.

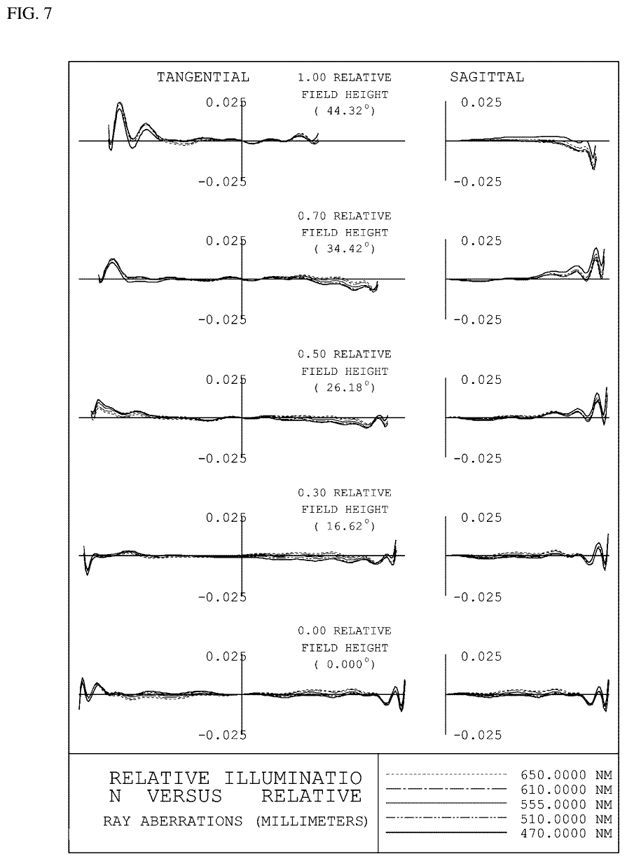

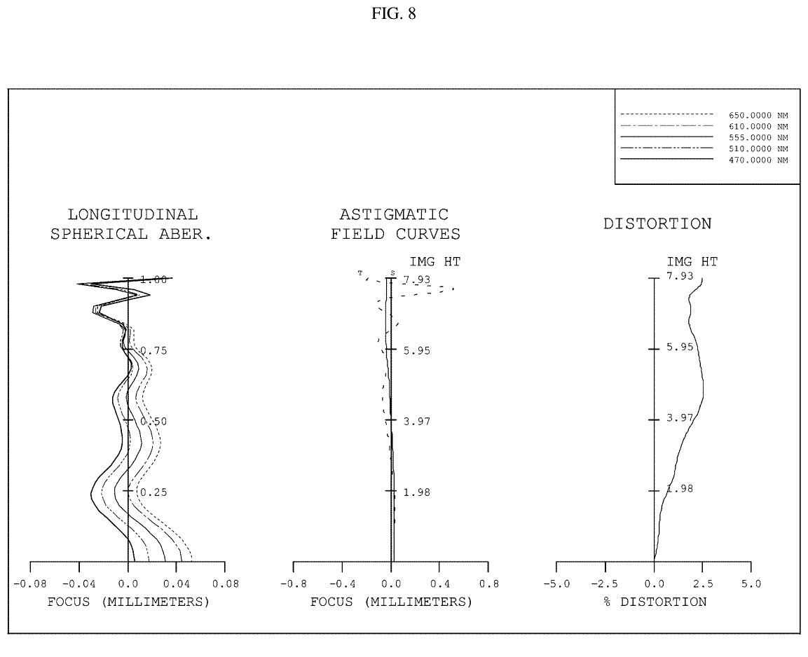

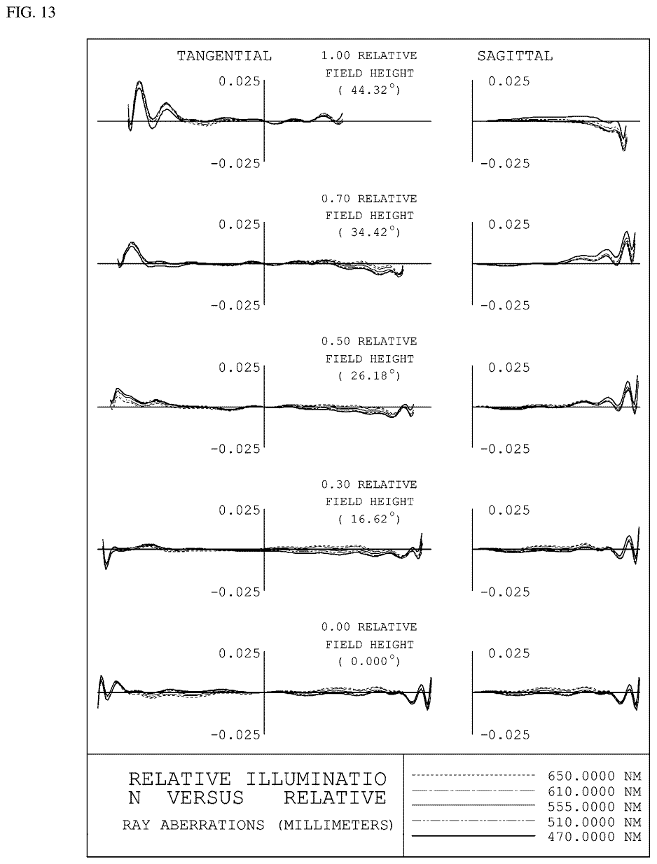

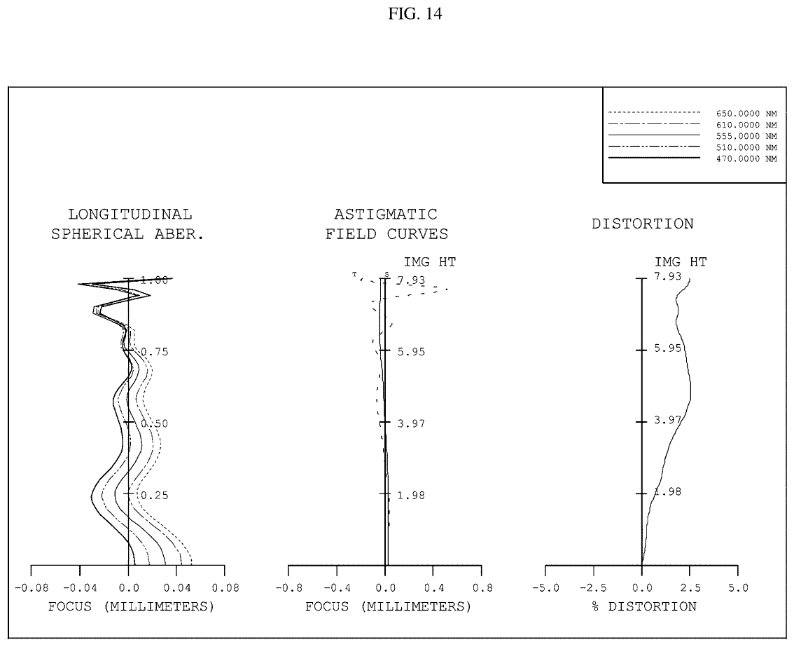

FIG. 7 is a graph showing the ray aberration characteristics of the optical system according to the first embodiment of the invention, FIG. 8 is a graph showing the aberration characteristics of the optical system according to the first embodiment of the invention, FIG. 13 is a graph showing the ray aberration characteristics of the optical system according to the second embodiment of the invention, and FIG. 14 is a graph showing the aberration characteristics of the optical system according to the second embodiment of the invention.

As shown in FIGS. 7, 8, 13 and 14, it is an analysis graph showing the lateral aberration in the region where the relative field height on the optical axis is 0.0 to 1.0 in the tangential field curve and the sagittal field curve by the optical system according to the first and second embodiments, and it may be confirmed that an optical system with good correction of lateral aberration may be obtained for light in the wavelength bands of about 470 nm, about 510 nm, about 555 nm, about 610 nm, and about 650 nm. That is, the optical system 1000 according to the embodiments may have improved resolving power and good optical performance not only at the center portion of the FOV but also at the periphery portion. As confirmed in the above examples, the lens systems of the first and second embodiments according to the invention are compact and lightweight with a lens configuration of 8 sheets, and at the same time, spherical aberration, astigmatism, distortion aberration, chromatic aberration, and coma aberration are all good. Since it may be calibrated and implemented with high resolution, it may be used by being embedded in the optical device of the camera.

Table 1 relates to the items of the above-mentioned equations in the optical system 1000 according to the first and second embodiments, and relates TTL, BFL, total effective focal length F value of the optical system 1000, ImgH, focal lengths (F1, F2, F3, F4, F5, F6, F7, F8) of each of the first to eighth lenses, edge thickness, edge distances, composite focal length, and the like.

TABLE 1

| | Embod- | Embod- | | Embod- | Embod- |
|---|---|---|---|---|---|
| Items | iment 1 | iment 2 | Items | iment 1 | iment 2 |
| F | 7.952 | 8.031 | ET1 | 0.350 | 0.364 |
| F1 | 8.417 | 7.948 | ET2 | 0.397 | 0.428 |
| F2 | −21.316 | −17.949 | ET3 | 0.280 | 0.282 |
| F3 | 22.631 | 22.245 | ET4 | 0.283 | 0.288 |
| F4 | −146.012 | −121.687 | ET5 | 0.353 | 0.356 |
| F5 | 29.921 | 29.935 | ET6 | 0.593 | 0.608 |
| F6 | −96.098 | −106.623 | ET7 | 0.399 | 0.399 |
| F7 | 130.516 | 126.545 | ET8 | 0.402 | 0.395 |
| F8 | −8.570 | −8.531 | EG1 | 0.081 | 0.080 |
| F13 | 8.544 | 8.537 | EG2 | 0.185 | 0.176 |
| F48 | −13.676 | −13.447 | EG3 | 0.234 | 0.215 |
| F12 | 12.503 | 12.564 | EG4 | 0.420 | 0.412 |
| F38 | −401.010 | −364.426 | EG5 | 0.102 | 0.100 |
| Inf61 | 1.434 | 1.428 | EG6 | 0.166 | 0.151 |
| Inf62 | 1.773 | 1.758 | EG7 | 0.958 | 0.935 |
| Inf71 | 1.492 | 1.481 | ΣIndex | 11.214 | 12.703 |
| Inf72 | 2.101 | 2.111 | ΣAbbe | 237.691 | 293.420 |
| FOV | 88.630 | 88.230 | ΣCT | 4.504 | 4.546 |
| EPD | 4.032 | 4.072 | ΣCG | 3.153 | 3.100 |
| BFL | 0.980 | 1.001 | CT_Max | 1.103 | 1.098 |
| TD | 7.656 | 7.646 | CA_Max | 12.165 | 15.870 |
| ImgH | 7.935 | 7.935 | CA_Min | 3.400 | 3.400 |
| SD | 6.373 | 6.330 | CA_Aver | 5.937 | 7.395 |
| F# | 1.972 | 1.972 | | | |
| TTL | 8.636 | 88.230 | | | |

Table 2 is for the result values for Equations 1 to 40 described above in the optical system 1000 of FIG. 1. Referring to Table 2, it may be seen that the optical system 1000 satisfies at least one, two or more, or three or more of Equations 1 to 40. In detail, it may be seen that the optical system 1000 according to the embodiment satisfies all of Equations 1 to 40. Accordingly, the optical system 1000 may improve optical performance and optical characteristics at the center portion and the periphery portion of the FOV.

TABLE 2

| Equations | | Embodiment 1 | Embodiment 2 |
|---|---|---|---|
| 1 | 2 < CT1/CT2 < 4 | 3.252 | 3.397 |
| 2 | 1 < CT3/ET3 < 2 | 1.595 | 1.593 |
| 3 | 0 < ET8/CT8 < 2 | 0.670 | 0.658 |
| 4 | 1.60 < n2 | 1.696 | 1.681 |
| 5 | 0.5 < L8S2_max_sag | 0.600 | 0.961 |
| | to Sensor < 1.5 | | |
| 6 | 1 < BFL/L8S2_max_sag | 1.633 | 1.041 |
| | to Sensor < 2 | | |
| 7 | 5 < \|L8S2_max slope\| < 65 | 36.530 | 36.620 |
| 8 | 1 < Inf82 < 1.5 | 1.300 | 1.300 |
| 9 | 1 < CG7/G7_min < 15 | 9.141 | 0.752 |
| 10 | 0 < CG7/EG7 < 2 | 0.988 | 0.952 |
| 11 | 0.01 < CG1/CG6 < 1 | 0.090 | 0.072 |
| 12 | 0 < CT1/CT7 < 2 | 0.855 | 0.897 |
| 13 | 0 < CT6/CT7 < 3 | 0.367 | 0.364 |
| 14 | 0 < \| L7R2/L8R1 \| < 2 | 0.790 | 0.795 |
| 15 | 0 < (CG6-EG6)/(CG6) < 2 | 0.700 | 0.728 |
| 16 | 1 < CA_L1S1/CA_L3S1 < 2 | 1.201 | 1.197 |
| 17 | 1 < CA_L7S2/CA_L4S2 < 5 | 2.360 | 2.357 |
| 18 | 0.5 < CA_L3S2/CA_LAS1 < 1.5 | 0.922 | 0.927 |
| 19 | 0.1 < CA_L5S2/CA_L7S2 < 1 | 0.549 | 0.552 |
| 20 | 1 < CA_L8S2/CA_L1S1 < 5 | 2.896 | 2.891 |
| 21 | 0.8 < CG3/EG3 < 5 | 1.926 | 2.130 |
| 22 | 1 < CG6/EG6 < 5 | 2.432 | 2.644 |
| 23 | 0 < G7_max/CG7 < 2 | 1.000 | 1.000 |
| 24 | 0 < CT6/CG6 < 2 | 0.729 | 0.719 |
| 25 | 1 < CT6/CG5 < 3 | 1.755 | 1.766 |
| 26 | 0.1 < CT7/CG5 < 1 | 0.570 | 0.566 |
| 27 | 50 < \|L5R2/CT5\| < 400 | 162.072 | 137.383 |
| 28 | 0 < L5R1/L7R1 < 10 | 2.436 | 2.338 |
| 29 | 0 < L1R1/L1R2 < 1 | 0.382 | 0.341 |
| 30 | 0 < L2R2/L2R1 < 1 | 0.626 | 0.553 |
| 31 | 0 < CT_Max/CG_Max < 2 | 1.165 | 1.000 |
| 32 | 0.5 < ΣCT/ΣCG < 2 | 1.429 | 1.467 |
| 33 | 10 < ΣIndex < 30 | 11.214 | 12.703 |
| 34 | 10 < ΣAbb/ΣIndex < 50 | 21.195 | 23.098 |
| 35 | 0 < \|Max_distoriton\| < 5 | 2.500 | 2.492 |
| 36 | 0 < EG_Max/CT_Max < 2 | 0.869 | 0.852 |
| 37 | 0.5 < CA_L1S1/CA_min < 2 | 1.235 | 1.235 |
| 38 | 1 < CA_max/CA_min < 5 | 3.578 | 3.571 |
| 39 | 1 < CA_max/CA_AVR < 3 | 2.049 | 2.053 |
| 40 | 0.1 < CA_min/CA_AVR < 1 | 0.573 | 0.575 |

Table 3 is for the result values for Equations 41 to 80 described above in the optical system 1000 of FIG. 1. Referring to Table 3, the optical system 1000 may satisfy at least one or two or more of Equations 1 to 40 and at least one, two or more, or three or more of Equations 41 to 80. In detail, it may be seen that the optical system 1000 according to the embodiment satisfies all of Equations 1 to 80. Accordingly, the optical system 1000 may improve optical performance and optical characteristics at the center portion and the periphery portion of the FOV.

TABLE 3

| | | Embodiment | Embodiment |
|---|---|---|---|
| Equations | | 1 | 2 |
| 41 | 0.1 < CA_max/(2*ImgH) < 1 | 0.767 | 0.765 |
| 42 | 0.1 < TD/CA_max < 1.5 | 0.629 | 0.630 |
| 43 | 0 < F/L7R2 < 5 | 1.428 | 1.431 |
| 44 | 1 < F/L1R1 < 10 | 2.668 | 2.699 |
| 45 | 0 < EPD/L8R2 < 5 | 0.296 | 0.304 |
| 46 | 0.5 < EPD/L1R1 < 8 | 1.353 | 1.369 |
| 47 | −5 < F1/F2 < 0 | −0.395 | −0.443 |
| 48 | 1 < F12/F < 5 | 1.572 | 1.564 |
| 49 | 1 < \|F48/F13\| < 4 | 1.601 | 1.575 |
| 50 | 0 < F1/F < 3 | 1.058 | 0.990 |
| 51 | 0 < F1/F13 < 2 | 0.985 | 0.931 |
| 52 | 0 < \| F1/F48 \| < 2 | 0.615 | 0.591 |
| 53 | 0 < \|F1/F4\| < 1 | 0.058 | 0.065 |
| 54 | 2 < TTL < 20 | 8.636 | 8.647 |
| 55 | 2 < ImgH | 7.935 | 7.935 |
| 56 | BFL < 2.5 | 0.980 | 1.001 |
| 57 | 2 < F < 20 | 7.952 | 8.031 |
| 58 | FOV < 120 | 88.630 | 88.230 |
| 59 | 0.5 < TTL/CA_max < 2 | 0.710 | 0.712 |
| 60 | 0.5 < TTL/ImgH < 3 | 1.088 | 1.090 |
| 61 | 0.01 < BFL/ImgH < 0.5 | 0.124 | 0.126 |
| 62 | 4 < TTL/BFL < 10 | 8.812 | 8.638 |
| 63 | 0.5 < F/TTL < 1.5 | 0.921 | 0.929 |
| 64 | 3 < F/BFL < 10 | 8.114 | 8.023 |
| 65 | 0 < F/ImgH < 3 | 1.002 | 1.012 |
| 66 | 1 < F/EPD < 5 | 1.972 | 1.972 |
| 67 | 0 < BFL/TD < 0.3 | 0.128 | 0.131 |
| 68 | 0 < EPD/ImgH/FOV < 0.2 | 0.006 | 0.006 |
| 69 | 5 < FOV/F# < 50 | 44.935 | 44.733 |
| 70 | 0 < n1/n2 < 1.5 | 0.905 | 0.913 |
| 71 | 0 < n3/n4 < 1.5 | 0.913 | 0.918 |
| 72 | 0 < Inf61/Inf62 < 1 | 0.809 | 0.812 |
| 73 | 0 < Inf61/Inf72 < 1 | 0.683 | 0.676 |
| 74 | 0 < Inf62/Inf72 < 1 | 0.844 | 0.833 |
| 75 | 0 < Inf61/semi-Aperture_L6S1 < 1 | 0.517 | 0.517 |
| 76 | 0 < Inf62/semi-Aperture_L6S2 < 1 | 0.465 | 0.468 |
| 77 | 0 < Inf71/semi-Aperture_L7S1 < 0.9 | 0.346 | 0.350 |
| 78 | 0 < Inf72/semi-Aperture_L7S2 < 0.9 | 0.444 | 0.448 |
| 79 | 0 < \|Max_Sag71\|/semi- | 0.234 | 0.236 |
| | Aperture_L7S1 < 0.8 | | |
| 80 | ( < \|Max_Sag72\|/semi- | 0.362 | 0.361 |
| | Aperture_L7S2 < 0.8 | | |

FIG. 16 is a diagram illustrating that a camera module according to an embodiment is applied to a mobile terminal.

Referring to FIG. 16, the mobile terminal 1 may include a camera module 10 provided on the rear side. The camera module 10 may include an image capturing function. In addition, the camera module 10 may include at least one of an auto focus function, a zoom function, and an OIS function.

The camera module 10 may process a still image or video frame obtained by the image sensor 300 in a shooting mode or a video call mode. The processed image frame may be displayed on a display unit (not shown) of the mobile terminal 1 and may be stored in a memory (not shown).

In addition, although not shown in the drawings, the camera module may be further disposed on the front side of the mobile terminal 1.

For example, the camera module 10 may include a first camera module 10A and a second camera module 10B. At this time, at least one of the first camera module 10A and the second camera module 10B may include the above-described optical system 1000. Accordingly, the camera module 10 may have a slim structure and may have improved distortion and aberration characteristics. In addition, the camera module 10 may have good optical performance even in the center and periphery portions of the FOV.

In addition, the mobile terminal 1 may further include an auto focus device 31. The auto focus device 31 may include an auto focus function using a laser. The auto-focus device 31 may be mainly used in a condition in which an auto-focus function using an image of the camera module 10 is degraded, for example, a proximity of 10 m or less or a dark environment. The autofocus device 31 may include a light emitting unit including a vertical cavity surface emitting laser (VCSEL) semiconductor device and a light receiving unit such as a photodiode that converts light energy into electrical energy.

In addition, the mobile terminal 1 may further include a flash module 33. The flash module 33 may include a light emitting element emitting light therein. The flash module 33 may be operated by a camera operation of a mobile terminal or a user's control.

Features, structures, effects, etc. described in the embodiments above are included in at least one embodiment of the invention, and are not necessarily limited to only one embodiment. Furthermore, the features, structures, and effects illustrated in each embodiment may be combined or modified with respect to other embodiments by those skilled in the art in the field to which the embodiments belong. Therefore, contents related to these combinations and variations should be construed as being included in the scope of the invention. Although described based on the embodiments, this is only an example, this invention is not limited, and it will be apparent to those skilled in the art that various modifications and applications not illustrated above are possible without departing from the essential characteristics of this embodiment. For example, each component specifically shown in the embodiment may be modified and implemented. And the differences related to these modifications and applications should be construed as being included in the scope of the invention as defined in the appended claims.

1. An optical system comprising:
first to eighth lenses disposed along an optical axis in a direction from an object side to a sensor side,
wherein the first lens has a positive (+) refractive power on the optical axis and has a convex object-side surface,
wherein when a refractive index (n1) of the first lens and the refractive index (n2) of the second lens, the following Equation satisfies: 0<n1/n2<1,
wherein a number of lenses having a meniscus shape convex toward the object side on the optical axis is five or more,
wherein each of object-side and sensor-side surfaces of the sixth lens has a critical point,
wherein each of object-side and sensor-side surfaces of the seventh lens has a critical point,
wherein the critical point of the sensor-side surface of the seventh lens is disposed further outside than the critical points of the object-side surface and the sensor-side surface of the sixth lens based on the optical axis,
wherein the sensor-side surface of the eighth lens has a concave shape on the optical axis,
wherein the object-side surface of the eighth lens is provided without a critical point, and
wherein the sensor-side surface of the eighth lens has a critical point.

2. The optical system of claim 1,
wherein the object-side surface of the eighth lens has a concave shape on the optical axis, and
wherein the critical point of the eighth lens is disposed closer to the optical axis than the critical points of the object-side and sensor-side surfaces of the sixth lens.

3. The optical system of claim 1,
wherein the refractive index of the first lens satisfies: 1.50<n1<1.6,
wherein the refractive index of the second lens satisfies: 1.65<n2.

4. The optical system of claim 1,
wherein the first, second, third, fifth, and sixth lenses have a meniscus shape convex toward the object side on the optical axis.

5. The optical system of claim 4,
wherein the seventh lens has a meniscus shape convex toward the object side on the optical axis.

6. The optical system of claim 1,
wherein a maximum effective diameter (CA_max) of an object-side surface and a sensor-side surface of the first to eighth lenses satisfies the following Equation: 0.1<CA_max/(2*ImgH)<1,
wherein the ImgH is ½ of a maximum diagonal length of an image sensor.

7. The optical system of claim 1,
wherein a sensor-side surface of the eighth lens has a maximum effective diameter (CA_max) among the object-side surfaces and sensor-side surfaces of the first to eighth lenses, and satisfies the following Equation: 0.5<TTL/CA_max<2
wherein the TTL is an optical axis distance from an object-side surface of the first lens to an image surface of an image sensor.

8. The optical system of claim 1,
wherein the focal length (F1) of the first lens and the total focal length (F) satisfies the following Equation: 0<F1/F<3.

9. The optical system of claim 8,
wherein the focal length (F1) of the first lens and a focal length (F2) of the second lens satisfies the following Equation: −1<F1/F2<0.

10. The optical system of claim 1,
wherein a center thickness (CT6) of the sixth lens and a center thickness (CT7) of the seventh lens satisfies the following Equation: 0<CT6/CT7<1.

11. The optical system of claim 4,
wherein an effective diameter of the object-side surface of the first lens is CA_L1S1,
wherein an object-side effective diameter of the third lens is CA_L3S1,
wherein a sensor-side effective diameter of the eighth lens is CA_L8S2, and
wherein the following Equations satisfy:
$$1 < CA\_L1S1 / CA\_L3S1 < 2$$
$$1 < CA\_L8S2 / CA\_L1S1 < 5 .$$

12. An optical system comprising:
first to third lenses disposed on an object side;
fourth to eighth lenses disposed on a sensor side; and
an aperture stop disposed around a sensor-side surface of any one of the first to third lenses,
wherein a sensor-side surface of the third lens faces an object-side surface of the fourth lens,
wherein the sensor-side surface of the third lens has a concave shape on an optical axis,
wherein the object-side surface of the fourth lens has a convex shape on the optical axis,
wherein the first to third lenses have a meniscus shape convex toward the object side on the optical axis,
wherein effective diameters of object-side and sensor-side surfaces of the first to third lenses gradually decrease from the object side toward the sensor side,
wherein effective diameters of object-side and sensor-side surfaces of the fourth to eighth lenses gradually increase from the object side toward the sensor side,
wherein the sensor-side surface of the eighth lens has a concave shape on the optical axis,
wherein the object-side surface of the eighth lens is provided without a critical point, and
wherein the sensor side surface of the eighth lens has a critical point.

13. The optical system of claim 12,
wherein a composite focal length from the first lens to the third lens is F13,
wherein a composite focal length from the fourth lens to the eighth lens is F48, and
wherein the following Equation satisfies: 1<|F48/F13|<4.

14. The optical system of claim 13,
wherein the aperture stop is disposed around the sensor-side surface of the second lens,
wherein a composite focal length from the first lens to the second lens is F12,
wherein a composite focal length from the third lens to the eighth lens is F38, and
wherein the following Equations satisfy:
$$F 12 > F 13$$
$$\vert F 38 \vert > \vert F 48 \vert .$$

15. The optical system of claim 12,
wherein the object-side surface and the sensor-side surface of the sixth lens have a critical point,
wherein the sensor-side surface of the seventh lens has a critical point,
wherein a distance from the optical axis to the critical point of the object-side surface of the sixth lens is Inf61,
wherein a distance from the optical axis to the critical point of the sensor-side surface of the sixth lens is Inf62,
wherein a distance from the optical axis to the critical point of the sensor-side surface of the seventh lens is Inf72, and
wherein the following Equations satisfy:
$$0 < Inf 61 / Inf 62 < 1$$
$$0 < Inf 61 / Inf 72 < 1$$
$$0 < Inf 62 / Inf 72 < 1 .$$

16. The optical system of claim 12,
wherein a curvature radius of the object-side surface of the first lens is L1R1,
wherein a curvature radius of the sensor-side surface of the first lens is L1R2,
wherein a curvature radius of the object-side surface of the second lens is L2R1,
wherein a curvature radius of the sensor-side surface of the second lens is L2R2, and
wherein the following Equations satisfy:
$$0 < L 1 R 1 / L 1 R 2 < 1$$
$$0 < L 2 R 2 / L 2 R 1 < 1.$$

17. The optical system of claim 12,
wherein the object-side surface and the sensor-side surface of the eighth lens have an aspheric shape on the optical axis,
wherein a distance between the sensor-side surface of the eighth lens and the image sensor
wherein the following Equation satisfies:
1<BFL/L8S2_max_sag to Sensor<2
wherein the BFL is an optical axis distance from a center of the sensor-side surface of the eighth lens to the image sensor, and
wherein the L8S2_max_sag to Sensor is a distance from a maximum Sag value of the sensor-side surface of the eighth lens to the image sensor.

18. The optical system of claim 12,
wherein a center thickness (CT1) of the first lens, a center thickness (CT2) of the second lens, and a center thickness (CT7) of the seventh lens satisfy the following Equations:
$$2 < CT 1 / CT 2 < 4$$
$$0 < CT 1 / CT 7 < 2 .$$

19. The optical system of claim 12,
wherein a sum (ΣCT) of center thicknesses of the first to eighth lenses and a sum (ΣCG) of distances between two adjacent lenses satisfy the following Equation:
$$1 < \sum CT / \sum CG < 1.8 .$$

20. A camera module comprising:
an image sensor; and
an optical filter disposed between the image sensor and a last lens,
wherein an optical system includes an optical system according to claim 1, and
wherein the following equations satisfy:
$$0.5 < F / TTL < 1.5$$
$$0.5 < TTL / ImgH < 3$$
(F is an average of a total focal lengths in two directions orthogonal to the optical axis of the optical system, TTL (Total track length) is a distance from a center of an object-side surface of the first lens to an image surface of the image sensor in the optical axis, and ImgH is ½ of a maximum diagonal length of the image sensor.).
